(19) United States
(12) Patent Application Publication
(10) Pub. No.: US 2022/0334854 A1
(43) Pub. Date: Oct. 20, 2022

(54) METHOD AND APPARATUS FOR OPERATING ELECTRONIC DEVICE, AND ELECTRONIC DEVICE AND STORAGE MEDIUM

(71) Applicant: Beijing Bytedance Network Technology Co., Ltd., Beijing (CN)

(72) Inventors: Chi FANG, Beijing (CN); Zengxing XING, Beijing (CN); Zechun LU, Beijing (CN); Diyuan WANG, Beijing (CN)

(21) Appl. No.: 17/762,001

(22) PCT Filed: Oct. 19, 2020
(86) PCT No.: PCT/CN2020/121823

§ 371 Date: Mar. 18, 2022

(30) Foreign Application Priority Data
Oct. 31, 2019 (CN) 201911063254.7

(51) Int. Cl. G06F 9/451; G06F 3/04886; G06F 3/04817; G06F 3/0485

(52) U.S. Cl. CPC G06F 9/451; G06F 3/04886; G06F 3/04817; G06F 3/0485; G06F 2203/04803; G06F 2203/04806

(57) ABSTRACT

A method and apparatus for operating an electronic device, and the electronic device and a storage medium. The method for operating the electronic device includes: receiving a partitioning display input for a user interface of the electronic device; and partitioning the user interface of the electronic device in response to the partitioning display input and displaying a partitioning result, wherein the partitioning result comprises a first display region and a second display region, the first display region can execute functions of a first function set, the second display region can execute functions of a second function set, the second display region comprises at least one window region, and each of the at least one window region is configured to be capable of displaying an application program window.

### CROSS-REFERENCE TO RELATED APPLICATIONS

This application is based on and claims the priority to the Chinese patent application No. 2019110632547 filed on Oct. 31, 2019, which is hereby incorporated by reference in its entirety into the present application.

### TECHNICAL FIELD

This disclosure relates to the field of user interface operation, and particularly, to a method and an apparatus of operating an electronic device, the electronic device and a storage medium.

### BACKGROUND

In the related art, only a window currently operated by a user is typically displayed on a user interface of an electronic device. In some cases, a user's operation may involve a plurality of windows. For example, when the user wishes to operate the current window with reference to content displayed in another window, it is needed to minimize the current window, open the another window, refer to the content displayed in the another window, minimize the another window, and open the current window, so that the current window can be operated.

The methods described in this section are not necessarily those that have been previously conceived or employed. Unless otherwise specified, it should not be assumed that any of the methods described in this section is considered as the prior art merely by virtue of their inclusion in this section. Similarly, the problems mentioned in this section should not be considered as having been widely acknowledged in any prior art, unless otherwise specified.

### SUMMARY

According to a first aspect of the present disclosure, there is provided a method of operating an electronic device, comprising: receiving a partition display input for a user interface of the electronic device; and in response to the partition display input, partitioning the user interface of the electronic device and displaying a partition result, wherein the partition result comprises a first display region and a second display region, the first display region being capable of performing functions of a first function set, the second display region being capable of performing functions of a second function set, the second display region comprising at least one window region, each window region in the at least one window region being configured to be capable of displaying one application window.

According to a second aspect of the present disclosure, there is provided a method of operating an electronic device, wherein a user interface of the electronic device comprises a first display region and a second display region, the second display region comprising at least one window region, a thirteenth application window being displayed in an eighth window region of the at least one window region in the second display region, the method comprising: receiving a switching input for the thirteenth application window; and in response to the switching input, activating the thirteenth application window, configuring the eighth window region as an updated first display region, and configuring the first display region as an updated eighth window region.

According to a third aspect of the present disclosure, there is provided an apparatus for operating an electronic device, comprising: an input receiving unit configured to receive a partition display input for a user interface of the electronic device; and a partition display unit configured to in response to the partition display input, partition the user interface of the electronic device and display a partition result, wherein the partition result comprises a first display region and a second display region, the first display region being capable of performing functions of a first function set, the second display region being capable of performing functions of a second function set, the second display region comprising at least one window region, each window region in the at least one window region being configured to be capable of displaying one application window.

According to a fourth aspect of the present disclosure, there is provided an electronic device, comprising: a processor; and a memory having therein stored a program, the program comprising instructions which, when executed by the processor, cause the processor to perform the method described in the present disclosure.

According to a fifth aspect of the present disclosure, there is provided a storage medium having therein stored a program, the program comprising instructions which, when executed by a processor of an electronic device, cause the electronic device to perform the method described in the present disclosure.

According to a sixth aspect of the present disclosure, there is provided a computer program product comprising a program, the program comprising code which, when executed by a processor of an electronic device, causes the electronic device to perform the method described in the present disclosure.

### BRIEF DESCRIPTION OF THE DRAWINGS

The accompanying drawings exemplarily illustrate embodiments and constitute a part of this specification, and together with the textual description of this specification, serve to explain exemplary implementations of the embodiments. The illustrated embodiments are for purposes of example only and do not limit the scope of the claims. In all the drawings, identical reference numbers refer to similar, but not necessarily identical, elements.

FIG. 1 is a flowchart illustrating a method according to an exemplary embodiment of the present disclosure;

FIG. 2A is a schematic diagram illustrating creation of an application window in at least one window region of a second display region of a user interface of an electronic device according to an exemplary embodiment of the present disclosure;

FIG. 2B is a schematic diagram illustrating creation of an application window in at least one window region of a second display region of a user interface of an electronic device according to another exemplary embodiment of the present disclosure;

FIG. 3 is a schematic diagram illustrating deletion of an application window from at least one window region of a second display region of a user interface of an electronic device according to an exemplary embodiment of the present disclosure;

FIG. 4 is a schematic diagram illustrating switching between an application window displayed in a first display region and an application window displayed in at least one window region of a second display region according to an exemplary embodiment of the present disclosure;

FIG. 5 is a schematic diagram illustrating copying of to-be-copied content from an application window displayed in a first display region to an application window in at least one window region of a second display region according to an exemplary embodiment of the present disclosure;

FIG. 6 is a schematic diagram illustrating copying of to-be-copied content from an application window displayed in a first display region to a chat tool application window in at least one window region of a second display region according to an exemplary embodiment of the present disclosure;

FIG. 7 is a structural block diagram illustrating an apparatus for operating an electronic device according to an exemplary embodiment of the present disclosure; and

FIG. 8 is a structural block diagram illustrating an exemplary electronic device applicable to an exemplary embodiment of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure can be implemented in various forms and should not be construed as limited to the embodiments set forth herein, and on the contrary, these embodiments are provided for a more complete and thorough understanding of the present disclosure. It should be understood that the drawings and the embodiments of the present disclosure are for exemplary purposes only and are not intended to limit the scope of the present disclosure.

It should be understood that various steps recited in a method implementation of the present disclosure can be executed in a different order and/or in parallel. Moreover, the method implementation can comprise additional steps and/or omit executing the steps shown. The scope of the present disclosure is not limited in this respect.

In this disclosure, various stages described in conjunction with the drawings can be executed in a different order and/or in parallel. The scope of the present disclosure is not limited in this respect.

A term “comprising” and its variations, which are used herein, are intended to be open-minded, i.e., “comprising but not limited to”. A term “based on” is “based at least in part on”. A term “one embodiment” denotes “at least one embodiment”; a term “another embodiment” denotes “at least one other embodiment”; and a term “some embodiments” denotes “at least some embodiments”. Relevant definitions for other terms will be given in the following description.

It should be noted that in this disclosure, unless otherwise specified, the use of terms “first”, “second”, . . . , “thirteenth” and the like to describe various elements is not intended to limit a position relation, time sequence relation, or importance relation of these elements, and such terms are used only for distinguishing one element from another. In some examples, a first element and a second element can refer to a same instance of the element, while in some cases they can refer to different instances based on the description of the context.

In addition, a term used in the description of the various examples in this disclosure is only for the purpose of describing specific examples and is not intended to be limiting. Unless specified in the context otherwise, if the number of an element is not specifically defined, the element can be one or more. Moreover, a term “and/or” used in this disclosure is intended to encompass any of and all of possible combinations of listed items.

Further, it should be noted that names of messages or information interacted between a plurality of devices in the implementation of the present disclosure are for illustrative purposes only, and are not intended to limit the scope of these messages or information.

In this disclosure, an “electronic device” can be any type of electronic device, for example, it can be, but is not limited to, a mobile terminal such as a mobile phone, a notebook computer, a digital broadcast receiver, a PDA (personal digital assistant), a PAD (tablet computer), a PMP (portable multimedia player), a vehicle-mounted terminal (for example, a vehicle-mounted navigation terminal), or the like, and a fixed terminal such as a digital TV, a desktop computer, or the like.

In this disclosure, a “program” is not limited to an application, but comprises a system desktop, a task manager, and the like.

In this disclosure, a “window” is a medium through which code or a program is displayed on a user interface of the electronic device. In particular, the “system desktop” is displayed on the user interface of the electronic device through a “system desktop window”, the “task manager” is displayed on the user interface of the electronic device through a “task manager window”, and the “application” is displayed on the user interface of the electronic device through an “application window”.

In this disclosure, unless otherwise specified, “interacting with a window” refers to interacting with content displayed in the window, not with the window itself. In particular, “interacting with a system desktop window” refers to interacting with content displayed in the system desktop window, “interacting with a task manager window” refers to interacting with content displayed in the task manager window, and “interacting with an application window” refers to interacting with content displayed in the application window.

In this disclosure, a “display region” is a portion of the user interface of the electronic device. In particular, “first display region”, “second display region”, “file display region”, and “application icon display region” all are portions of the user interface of the electronic device.

In this disclosure, a “window region” is a portion of the “display region” and is also a portion of the user interface of the electronic device. In particular, an “idle window region” refers to a window region in which any program window is not being displayed.

In the related art, only a window currently operated by a user is typically displayed on the user interface of the electronic device. In some cases, a user's operation may involve a plurality of windows. When the user wishes to operate the current window with reference to content displayed in another window, the user needs to perform the following operations: minimizing the current window, opening the another window, referring to the content displayed in the another window, minimizing the another window, and opening the current window again, so that he can continue to operate the current window. In these cases, the operation steps for switching between the windows are numerous and cumbersome. Furthermore, switching between the windows requires certain time. When the content required for reference is more, the user may forget a part of the reference content. At this time, the user may need to perform the above operation steps one or more times again, which further increases the operation steps and greatly affects the user experience.

To this end, the present disclosure provides a method of operating an electronic device, the method being capable of partitioning a user interface of the electronic device to at least partition the user interface into a first display region and a second display region. One window can be displayed in the first display region and at least one application window can be displayed in at least one window region of the second display region.

In this way, the user can operate the current window with reference to content displayed in the at least one application window displayed in the at least one window region of the second display region, without the need of switching the windows and worrying that the reference content will be forgotten, so that the user experience is good.

Furthermore, the method can allow the user to perform a plurality of jobs at the same time. For example, the user can view a video through a video playing application window displayed in the at least one window region of the second display region while chatting with a friend through a chat tool application window displayed in the first display region.

An exemplary embodiment of the method of operating the electronic device of the present disclosure will be further described below with reference to the accompanying drawings.

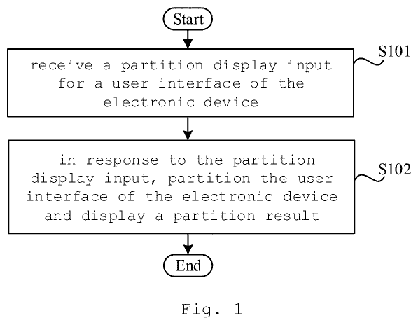

FIG. 1 is a flowchart illustrating a method of operating an electronic device according to an exemplary embodiment of the present disclosure.

In a first aspect of the present disclosure, a method of operating an electronic device can be comprised, which can comprise: receiving a partition display input for a user interface of the electronic device (step S101); and in response to the partition display input, partitioning the user interface of the electronic device and displaying a partition result (step S102). The partition result comprises a first display region and a second display region, the first display region being capable of performing a function of a first function set, the second display region being capable of performing a function of a second function set, the second display region comprising at least one window region, each window region in the at least one window region being configured to be capable of displaying one application window. The partition display input is an input for triggering partition display.

In the step S101, the partition display input can be implemented by an input for the user interface of the electronic device, according to some embodiments. The partition display input can comprise, for example, one or any combination of the following: a clicking input by clicking a partition display button displayed on the user interface, a sliding input by sliding on the user interface, a pressing input by pressing the user interface, a lifting input after a certain time of the above types of inputs. Of course, the partition display input according to the present disclosure is not limited thereto. The partition display input can be any form of input for any position of the user interface of the electronic device.

According to some embodiments, the partition display input can be implemented by a physical button or virtual button for the electronic device. For example, in response to pressing or sliding, by the user, a partition display button of the electronic device, the electronic device performs the partition display function.

According to some embodiments, the partition display input can be a voice input. The voice input can be received, for example, through an audio input device of the electronic device. For example, in response to a user's voice of “starting partition”, the electronic device performs the partition display function.

According to some embodiments, in the step S102, in response to the partition display input, the user interface is partitioned and the partition result is displayed. The partitioned result can comprise two or more display regions. These display regions may or may not overlap each other. According to some examples, the partition result can comprise the first display region and the second display region, both of which are, as described above, portions of the user interface of the electronic device.

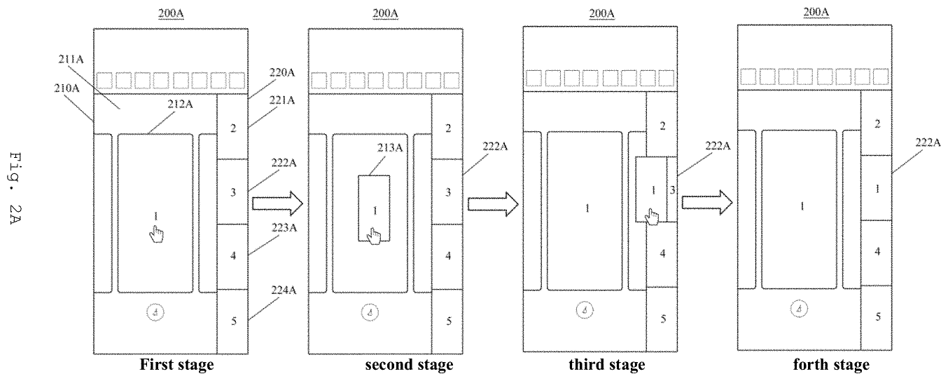

A method of operating an electronic device according to an exemplary embodiment of the present disclosure will be described below in conjunction with FIG. 2A. FIG. 2A is a schematic diagram illustrating creation of an application window in at least one window region of a second display region of a user interface of an electronic device according to an exemplary embodiment of the present disclosure.

Referring to an example shown in FIG. 2A, in response to the partition display input, a user interface 200A of the electronic device is partitioned and a partition result is displayed, wherein the partition result comprise a first display region 210A and a second display region 220A.

According to some embodiments, the first display region being capable of performing functions of a first function set means that all of the functions in the first function set can be performed by the first display region, but it is not required that all of the functions in the first function set are being performed by the first display region. For example, the first display region is capable of displaying a program window, but at a certain moment of time, a task manager window (one case of the program window) can be being displayed in the first display region.

According to some embodiments, the second display region being capable of performing functions of a second function set means that all of the functions in the second function set can be performed by the second display region, but it is not required that that all of the functions in the second function set are being performed by the second display region. For example, the second display region is capable of displaying an application window, but at a certain moment of time, the second display region may not display any window (idle).

It should be noted that a “program window” as indicated herein can comprise all program windows that can be displayed on the user interface of the electronic device, the program window comprising but not limited to a system desktop window, a task manager window, an application window, and the like.

According to some embodiments, the functions of the first function set can comprise: displaying the system desktop window, allowing the user to interact with the system desktop window, displaying the task manager window, allowing the user to interact with the task manager window, displaying the application window, and allowing the user to interact with the application window. According to some embodiments, the second function set is a subset of the first function set.

According to some embodiments, as far as the first display region is concerned, the first display region is capable of displaying the system desktop window, allowing the user to interact with the system desktop window displayed in the first display region, displaying the task manager window, allowing the user to interact with the task manager window displayed in the first display region, displaying the application window, and allowing the user to interact with the application window displayed in the first display region.

According to some embodiments, as far as the second display region is concerned, as the second function set is the subset of the first function set, the second display region is incapable of performing all of the functions in the first function set, but the second display region is capable of at least displaying the application window according to the description above.

According to an example, the second display region is capable of displaying the system desktop window, displaying the task manager window, and displaying the application window, but does not allow the user to interact with the system desktop window displayed in the second display region, does not allow the user to interact with the task manager window displayed in the second display region, and does not allow the user to interact with the application window displayed in the second display region. According to another example, the second display region is capable of displaying the application window but does not allow the user to interact with the application window displayed in the second display region, and it is incapable of displaying the system desktop window and the task manager window and therefore does not allow the user to interact with the system desktop window and the task manager window.

In such a way, by the partition display input, the user enables the user interface of the electronic device to be capable of displaying at least two application windows through the first display region and the second display region that have different functions. The method of operating the electronic device according to the exemplary embodiment of the present disclosure can allow the user to operate the application window in the first display region by directly referring to the application window displayed in the second display region, and can allow the user to simultaneously perform two or more jobs in parallel by using at least two application windows displayed on the user interface of the electronic device. Furthermore, since the functions (the second function set) that can be performed by the second display region can be less than the functions (the first function set) that can be performed by the first display region, the second display region, which is typically used as reference, can occupy less system resources.

Although some embodiments of the first function set have been described above, it should be understood by those skilled in the art that the present disclosure is not limited thereto and the first function set can also comprise other functions that can be performed by the user interface of the electronic device.

According to some embodiments, the first function set comprises all of the functions that can be performed by the user interface of the electronic device. In other words, as far as the first display region is concerned, if one program window A can be displayed on the user interface of the electronic device, the program window A can also be displayed in the first display region, and the program window A, when displayed in the first display region, has all the functions that the program window A has when displayed on the user interface of the electronic device.

Since the second function set is the subset of the first function set, as far as the second display region is concerned, there are the following cases:

Case 1: one program window A can be displayed on the user interface of the electronic device, but the program window A cannot be displayed in the second display region; and

Case 2: another program window B can be displayed on the user interface of the electronic device, and the program window B can also be displayed in the second display region, but functions that the program window B has when displayed in the second display region are only a part of functions that the program window B has when displayed on the user interface of the electronic device.

According to some embodiments, the second display region comprises at least one window region, each window region in the at least one window region being configured to be capable of displaying one application window. According to some embodiments, the at least one window region is a portion of the second display region, and the second display region is capable of displaying at least one application window as each window region in the at least one window region is configured to be capable of displaying one application window. According to some embodiments, an application window that can be displayed in the first display region can fill the entire first display region. According to some other embodiments, the application window that can be displayed in the first display region can also incompletely fill the entire first display region. According to some embodiments, an application window that can be displayed in a window region of the second display region can fill the entire window region. According to other embodiments, an application window that can be displayed in the window region of the second display region can also incompletely fill the entire window region.

Referring to the example shown in FIG. 2A, the second display region 220A comprises four window regions 221A, 222A, 223A, 224A, in which an application 2 is displayed in the window region 221A, an application 3 is displayed in the window region 222A, an application 4 is displayed in the window region 223A, and an application 5 is displayed in the window region 224A. The example shown in FIG. 2A is described above only in conjunction with the example, but those skilled in the art should understand that the second display region can comprise arbitrary-positive-integer number of window regions.

According to some embodiments, the user interface of the electronic device can be a touch-sensitive user interface.

In some cases, when the user wishes that an application window that has not yet been displayed is displayed in the second display region, the application window can be created in the at least one window region of the second display region.

According to some embodiments, identification information corresponding to a first application is displayed in the first display region, and the method further comprises: receiving a first window creation input for the identification information displayed in the first display region and corresponding to the first application and a first window region in the at least one window region displayed in the second display region; and in response to the first window creation input, displaying, in the first window region, a first application window corresponding to the first application.

According to some embodiments, the identification information corresponding to the first application can comprise: at least one of the first application window corresponding to the first application, a first application tab in a task manager corresponding to the first application, and a first application icon in a system desktop corresponding to the first application.

According to some embodiments, in a case where the identification information corresponding to the first application is the first application window corresponding to the first application, the first application window can be displayed in the first display region. According to some embodiments, the first window creation input for the first application window and the first window region can comprise, for example, a clicking input or pressing input for the first application window and a clicking input or pressing input for the first window region. Of course, the present disclosure is not limited thereto, and the first window creation input for the first application window and the first window region can also comprise various types of input modes.

According to some embodiments, in a case where the identification information corresponding to the first application is the first application icon in the system desktop corresponding to the first application, a system desktop window can be displayed in the first display region, and the first application icon corresponding to the first application can be displayed in the system desktop window. According to some embodiments, the first window creation input for the first application icon and the first window region can comprise, for example, a clicking input or pressing input for the first application icon and a clicking input or pressing input for the first window region. Of course, the present disclosure is not limited thereto, and the first window creation input for the first application icon and the first window region can also comprise various types of input modes.

A window creation operation according to an exemplary embodiment of the present disclosure will be described below in conjunction with FIG. 2A.

According to some embodiments, in a case where the identification information corresponding to the first application is the first application tab of the task manager, a task manager window 211A corresponding to the task manager of the electronic device can be displayed in the first display region, and the method of operating the electronic device can further comprise: receiving a first window creation input for a first application window tab 212A in the task manager window 211A displayed in the first display region and a first window region 222A in the at least one window region displayed in the second display region, the first application window tab 212A corresponding to a first application window (application window 1); and in response to the first window creation input, displaying, in the first window region 222A, the first application window (application window 1) corresponding to the application window tab.

According to some embodiments, the task manager window can comprise a plurality of application tabs, each application tab corresponding to an application running in the background. In a case where the task manager window is displayed in the first display region, the user can create an application window in the at least one window region of the second display region through the task manager window.

According to some embodiments, creating the application window in the at least one window region of the second display region is accomplished by the first window creation input for the first application window tab and the first window region, wherein the first application window tab corresponds to the first application window, the first application window is the application window to be created to the first window region, and the first window region is a target window region for creating the first application window.

According to some embodiments, the first window creation input can comprise one type of input mode. According to some examples, the first window creation input can comprise a clicking input. By clicking the first application tab and the first window region, the user can cause the first application window corresponding to the first application tab to be created to the first window region. In other words, the first application window is displayed in the first window region. Of course, the present disclosure is not limited thereto. According to some other examples, the first window creation input can further comprise a sliding input, a pressing input, a lifting input, or the like.

According to some embodiments, the first window creation input can further comprise a combination of multiple types of input modes. According to some examples, the first window creation input can comprise a first portion, a second portion, and a third portion. For example, the first portion of the first window creation input can comprise a pressing input for the first application window tab, the second portion of the first window creation input can be a sliding input from the task manager window to the first window region in the at least one window region displayed in the second display region, and the third portion of the first window creation input can be a lifting input in the first window region.

According to some embodiments, the identification information is the first application tab in the task manager window corresponding to the first application, and in response to the first window creation input, the displaying, in the first window region, the first application window corresponding to the first application window tab can comprise: in response to the first window creation input, displaying a thumbnail of the first application window, causing the thumbnail of the first application window to move and enter the first window region, and displaying the first application window in the first window region.

Referring to FIG. 2A, according to some embodiments, as shown in first to second stages of FIG. 2A, in response to the first portion (for example, the pressing input) of the first window creation input, a thumbnail 213A of the first application window corresponding to the first application tab is displayed above the first application tab 212A displayed in the first display region.

According to some embodiments, the identification information is the first application tab in the task manager window corresponding to the first application, and in response to the first window creation input, the displaying the first application window in the first window region comprises: in response to the first window creation input, displaying a thumbnail of the first application window, causing the thumbnail of the first application window to move; and in response to detecting that the thumbnail of the first application window does not move and enter the first window region, not displaying the first application window in the first window region.

At this time, if the user wishes to forgo creating the first application window in the window region, the user can implement the lifting input. In response to the lifting input immediately following the first portion (for example, the pressing input) of the first window creation input, the thumbnail of the first application window is no longer displayed.

As shown in a third stage of FIG. 2A, in response to the second portion (for example, the sliding input) of the first window creation input, the thumbnail of the first application window can be dragged with the sliding input, and the thumbnail is moved to any position on the user interface, for example, the first window region in the second display region. The thumbnail is used in place of the first application window to move with the movement of the first window creation input, so that shielding of the user interface in a process of the movement can be minimized, and more information can be displayed on the user interface in the process of moving the thumbnail.

As shown in a fourth stage of FIG. 2A, in response to the third portion (for example, the lifting input) of the first window creation input, the first application window can be displayed in the first window region, thereby completing the creation of the application window in the window region of the second display region.

In such a way, through the first window creation input, the user can create the application window in the window region of the second display region.

In some cases, no application window was previously displayed in the first window region 222A. In other cases, however, as shown in FIG. 2A, a second application window (application window 3) different from the first application window (application window 1) may have been previously displayed in the first window region 222A. At this time, the second application window (application window 3) that has been previously displayed can also be removed from the first window region 222A.

According to some embodiments, the method of operating the electronic device can further comprise: before the first window creation input has been received, if a second application window (application window 3) corresponding to a second application is being displayed in the first window region 222A, in response to the first window creation input, removing the second application window (application window 3) from the first window region 222A.

According to some embodiments, the removal of the second application window from the first window region can be accomplished by various removal ways. The removal can be accomplished, for example, by a sliding input.

According to some embodiments, the method of operating the electronic device can further comprise: detecting an entry speed of the thumbnail of the first application window when entering the first window region; comparing the entry speed with a speed threshold; and if the entry speed is greater than the speed threshold, the removing the second application window from the first window region comprising: no longer displaying the second application window in the first window region, and displaying the first application window.

According to some embodiments, the electronic device can detect a sliding speed of the second portion (for example, the sliding input) of the first window creation input at any moment, such as the entry speed of the thumbnail of the first application window when entering the first window region. The entry speed can be, for example, an instantaneous speed of the thumbnail when contacting an edge of the first window region on the user interface. When the entry speed is relatively high, for example, the entry speed is greater than the speed threshold, the second application window can be caused to disappear in the first window region and the first application window can be directly displayed instead. The speed threshold can be preset by the user or defaulted by the system. The speed threshold can be, for example, 1 cm/s, 2 cm/s, 5 cm/s, or the like. When the entry speed is relatively high, it may show that a user's desire that the first application window is wished to be displayed in the first window region is urgent. At this time, by directly removing the second application window and directly displaying the first application window, the creation of the first application window in the window region can be completed more quickly, which improves the user experience.

According to some embodiments, the method of operating the electronic device can further comprise: detecting an entry speed of the thumbnail of the first application window when entering the first window region; comparing the entry speed with a speed threshold; and if the entry speed is less than or equal to the speed threshold, the removing the second application window from the first window region comprising: determining a first direction based on a position of the first window region in the user interface of the electronic device; and causing the second application window to move in the first direction and move out of the first window region, as shown in the third stage of FIG. 2A.

According to some embodiments, when the entry speed is relatively low, for example, the entry speed is less than the speed threshold, the entry of the first application window and the removal of the second application window can be displayed simultaneously with the sliding of the second portion (for example, the sliding input) of the first window creation input.

According to some embodiments, in order to make the removal of the second application window more natural to the user and make the removal of the second application window not affect content display of other regions of the user interface, the first direction can be determined based on the position of the first window region in the user interface of the electronic device. According to some examples, the first direction can be determined to be horizontally rightward when the first window region is located on a right side of the user interface; and the first direction can be determined to be horizontally leftward when the first window region is located on a left side of the user interface. Of course, the present disclosure is not limited thereto. In this way, the second application window can be caused to be capable of always moving out horizontally towards an outside of the user interface, and compared with removing the second application window towards an inside of the user interface, removing the second application window towards the outside of the user interface will not shied other regions and will not affect normal display of the other regions.

In addition, causing both the first application window and the second application window to move in a same direction (i.e., the first direction) can exhibit an animation effect that the first application window newly created in the first window region extrudes the second application window previously displayed. For example, as shown in the third stage of FIG. 2A, the first window region 222A is located on a right side of the user interface 200A, and the entry direction causes the first application window (application window 1) to enter the first window region 222A from the left of the first window region 222A in a horizontally rightward direction, and causes the second application window (application window 3) to move horizontally rightward from the right of the first window region 222A and move out of the first window region 222A.

Furthermore, when the entry speed is relatively low, it can be indicated that the user's desire that the first application window is wished to be displayed in the first window region is less urgent. According to some examples, during implementation of the second portion of the first window creation input, if the user no longer wishes to create the first application window in the first window region, he can cause the thumbnail of the first application window to exit the first window region. In such a way, more time for consideration is provided for the user, so that the mistaken operation is avoided, and the user experience is improved.

According to some embodiments, the method of operating the electronic device can further comprise: in response to removing the second application window from the first window region, running the second application window in the background if the second application window is locked by the task manager; and closing the second application window if the second application window is not locked by the task manager.

According to some embodiments, typically, the removal of the second application window means the closing of the second application window. However, the user may not wish to close the second application window with the removal of the second application window. Therefore, the user can lock the second application window through the task manager in advance. After the second application window is locked by the task manager, it can still run in the background even if the second application window is removed from the first window region due to the first window creation input.

According to some other embodiments, the removal of the second application window does not mean the closing of the second application window, but rather causing the second application window to automatically enter the task manager, in other words, running the second application window in the background.

According to some embodiments, the method of operating the electronic device can further comprise: before the first window creation input has been received, if the second application window corresponding to the second application is being displayed in the first window region and if no application window is being displayed in the second window region in the at least one window region displayed in the second display region, moving the second application window to the second window region in response to the first window creation input.

According to some embodiments, if in the second display region, there is still a second window region in which no application window is being displayed, as long as the user moves the thumbnail of the first application window to the second display region, the first application window can be caused to be displayed in the second window region in which no application window is being displayed. In other words, the electronic device detects that in the second display region, there is still a second window region (i.e., an idle window region) in which no application window is being displayed, and in response to having received the first window creation input, the first application window is displayed in the second window region (i.e., the idle window region) of the second display region.

In this way, when there is the idle window region in the second display region, the user does not need to precisely drag the thumbnail of the first application window to the first window region, but only needs to drag the thumbnail to an arbitrary position of the second display region. This simplifies the first window creation input for creating the application window in the window region and improves the user experience.

The first window creation input for the task manager window displayed in the first display region and the at least one window region of the second display region has been described in detail above. In other cases, particularly in a case where there is the idle window region in the second display region, the application window can also be created in the second display region by a second window creation input for the idle window region of the second display region.

According to some embodiments, an eleventh application window is displayed in the first display region, and the method of operating the electronic device can further comprise: receiving a second window creation input for one arbitrary idle window region in the second display region; and in response to the second window creation input, displaying the eleventh application window in the second display region.

As already defined above, the idle window region refers to a window region in which any program window is not being displayed. According to some embodiments, the second window creation input for the one arbitrary idle window region in the second display region means that an object of the second window creation input is the idle window region. In other words, when the second window creation input is received, in the second display region, there are one or more idle window regions in which any program window is not displayed.

According to some embodiments, the second window creation input can be a clicking input, a pressing input, etc. for the one arbitrary idle window region.

According to some implementations, when the second window creation input is received, there is one idle window region in the second display region. In response to the second window creation input, the eleventh application window can be displayed in the idle window region.

According to some embodiments, the electronic device can judge whether one window region is the idle window region. For example, the electronic device can detect whether an application window is being displayed in a display region corresponding to the one window region.

According to some embodiments, the displaying the eleventh application window in the second display region can further comprise: displaying the eleventh application window in the one arbitrary idle window region in the second display region, or displaying the eleventh application window in one idle window region adjacent to an occupied window region, in the second display region, or displaying the eleventh application window in an idle window region closest to a triggering position of the second window creation input, in the second display region.

According to some implementations, when the second window creation input is received, there are a plurality of idle window regions in the second display region. According to some examples, in response to the second window creation input, the eleventh application window can be displayed in that idle window region for which the second window creation input is.

Of course, according to other examples, in response to the second window creation input, the eleventh application window can be displayed in a predetermined window region in the plurality of idle window regions, whereas the eleventh application window need not be displayed in that idle window region for which the second window creation input is.

According to some embodiments, in which idle window region the eleventh application window is displayed can be determined according to a preset strategy. According to some examples, the electronic device can, when having received the second window creation input, detect a position of the second window creation input and determine an idle window region closest to the position as the idle window region for displaying the eleventh application. According to some examples, the electronic device can, when having received the second window creation input, detect that the second window creation input is located in a specific window region and determine an idle window region adjacent to the specific window region as the idle window region for displaying the eleventh application. According to some examples, the electronic device can, when having received the second window creation input, detect a position of an already occupied window region in the second display region and select a target window region from idle window regions based on the display position of the already-occupied window region, such as taking an idle window region adjacent to the occupied window region as the target window region.

According to some embodiments, in a state where the second window creation input has been received, the method can further comprise: determining the target window region from the idle window regions based on the position of the already occupied window region or positions of the idle window regions; and displaying the eleventh application window in the target window region.

After the second window creation input has been received, the target window region is determined from the idle window regions according to the preset strategy based on the position of the already occupied window region or the positions of the idle window regions, and in the target window region, an application window displayed in the first display region when the second window creation input has been received is displayed, that is, the eleventh application window is displayed in the target window region, so that a valid input region of the second window creation input can be expanded, and while the idle window is effectively utilized, the requirements for an accurate operation are reduced and the tolerance of an operation range is improved. Moreover, since the determination of the target window region is based on the preset strategy, the position of the target window region can be predicted on the premise of knowing which windows are occupied, which is more convenient to rapidly position the target window region and therefore improves the information acquisition efficiency.

In a case where there are one or more idle window regions in the second display region, by means of merely the second window creation input for the one arbitrary idle window region of the one or more idle window regions, without an input for the eleventh application window in the first display region, the eleventh application window previously displayed in the first display region can be displayed in the second display region by the user. In such a way, the operation of the user is further simplified, and the user experience is improved.

According to some embodiments, the method can further comprise: in response to the first window creation input, displaying, in the first display region, the system desktop window or the task manager window or the application window.

A process of creating an application window in the second display region where there is an idle window region will be described in detail below in conjunction with FIG. 2B. FIG. 2B is a schematic diagram illustrating creation of an application window in at least one window region of a second display region of a user interface of an electronic device, according to another exemplary embodiment of the present disclosure.

Referring to a first stage of FIG. 2B, a user interface 200B comprises a first display region 210B and a second display region 220B. An eleventh application window (for example, a clock-type application window, as shown in FIG. 2B) is being displayed in the first display region 210B. The second display region 220B comprises four window regions 221B, 222B, 223B, 224B, all of which are idle window regions.

As shown in the first stage of FIG. 2B, the user applies a second window creation input (for example, a clicking input) for one idle window region 222B of the four idle window regions. As shown in a second stage of FIG. 2B, in response to the second window creation input, the eleventh application window (for example, the clock-type application window) that was previously displayed in the first display region is displayed in another idle window region 221B. According to some embodiments, when the electronic device has received the second window creation input, a default setting is to display the eleventh application window in an uppermost idle window region. In this way, the position where the eleventh application window is displayed is default (predictable), without having to seek a display position of the eleventh application window any longer.

According to some embodiments, the default setting can be that the eleventh application window is displayed in an idle window region located at one end of all the idle window regions. According to some embodiments, as described above, in response to the second window creation input, the default setting can be that the eleventh application window is displayed in the uppermost idle window region. For example, as shown in the second stage in FIG. 2B, since all of the four window regions are idle window regions, no matter which window region in the window regions 221B, 222B, 223B, 224B the second window creation input is for, the eleventh application window is displayed in the window region 221B (the uppermost idle window region) in response to the second window creation input. Of course, the present disclosure is not limited thereto, and the default setting can also be that the eleventh application window is displayed in a lowermost idle window region. According to other embodiments, for example, in a case where the window regions in the second display region are arranged in a horizontal direction, the default setting can be that the eleventh application window is displayed in a leftmost or rightmost idle window region.

In such a way, the arrangement of the window regions in which the application windows are being displayed can be made more compact, which facilitates user's operation and viewing. Furthermore, this makes the position where the eleventh application window is displayed predictable, without having to seek the display position of the eleventh application window any longer.

According to some embodiments, the method of operating the electronic device can further comprise: in response to the second window creation input, displaying a system desktop window 211B in the first display region.

Since the eleventh application window previously displayed in the first display region has already been displayed in the second display region, the system desktop window 211B can be displayed in the first display region in response to the second window creation input, thereby facilitating display of other application windows in the first display region through the user's subsequent further operation for the system desktop window (for example, an application icon in the system desktop window).

Of course, the present disclosure is not limited thereto. According to some embodiments, in response to the second window creation input, the display of the eleventh application window can be continued in the first display region. According to some other embodiments, in response to the second window creation input, the task manager window can be displayed in the first display region. According to still other embodiments, in response to the second window creation input, another application window displayed before the eleventh application window can be displayed in the first display region.

In some cases, when the user does not wish that an application window is displayed in the at least one window region of the second display region, the application window can be deleted.

According to some embodiments, the method of operating the electronic device can further comprise: in a state where a third application window corresponding to a third application is being displayed in a third window region in the at least one window region, receiving a window deletion input for the third application window; and in response to the window deletion input, removing the third application window from the third window region. In this way, by the window deletion input, the application window that is being displayed in the window region can be deleted by the user.

For example, the window deletion input can comprise a clicking input for a window deletion button of the third application window, a pressing input for the third application window, or a combination thereof.

According to some embodiments, the third application window can be removed in various ways.

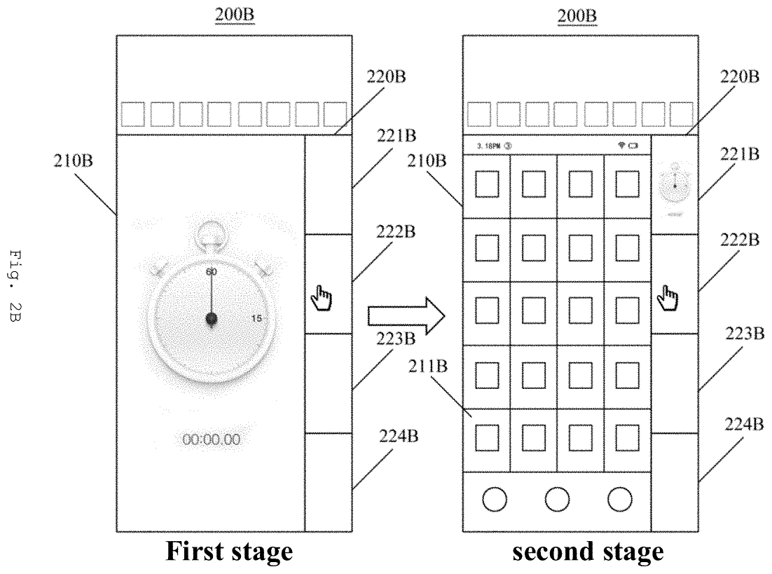

A window deletion operation according to an exemplary embodiment of the present disclosure will be described below with reference to FIG. 3. FIG. 3 is a schematic diagram illustrating deletion of an application window from at least one window region of a second display region of a user interface of an electronic device according to an exemplary embodiment of the present disclosure.

As shown in a first stage of FIG. 3, a user interface 300 comprises a first display region 310 and a second display region 320, wherein the second display region 320 comprises window regions 321, 322, 323, 324. An application window 1 is displayed in the first display region, and an application window 2, an application window 3, an application window 4, and an application window 5 are displayed in the four window regions of the second display region, respectively.

According to some embodiments, for example, as shown in first to second stages of FIG. 2A, the removing the third application window (application window 3) from the third window region 322 can further comprise: selecting the third application window (referring to the first stage in FIG. 2A), and causing the third application window to move in a second direction and move out of the third window region (referring to the second stage in FIG. 2A).

In addition to the removal mode of movement, according to other embodiments, the third application window can also be removed by means of directly disappearing, zooming-out disappearing, or the like.

According to some embodiments, the causing the third application window to move in a second direction and move out of the third window region can further comprise: detecting a movement direction of the window deletion input; determining the second direction (which is horizontally rightward as shown in the second stage of FIG. 2A) based on the movement direction; and causing the third application window to move in the second direction and move out of the third window region. According to some embodiments, the window deletion input can comprise a sliding input for the third application window.

According to some embodiments, the second direction in which the third application window moves and moves out of the third window region can be determined through a movement direction of the sliding input. The determination method is as follows: establishing a coordinate system with a horizontally rightward direction relative to the electronic device as a positive x-axial direction, a vertically upward direction relative to the electronic device as a positive y-axial direction, and a starting point of the movement direction as an origin; using a unit vector to represent the movement direction; projecting the unit vector onto an x-axis and a y-axis; comparing projection lengths of the unit vector on a positive x-axis, a negative x-axis, a positive y-axis and a negative y-axis respectively; and taking an axial direction with a maximum projection length as the second direction. For example, when the user implements the window deletion input with a 15-degree upward deviation from the horizontal direction, the third application window is caused to move in a horizontally rightward direction and move out of the third window region.

According to some embodiments, the removing the third application window from the third window region can further comprise: configuring the third window region as an idle window region. According to some embodiments, the method can further comprise: determining an automatic floating direction; and in response to existence of an idle window region in the at least one window region in the second display region, causing application windows displayed in the second display region to move in the automatic floating direction and fill the idle window region in sequence, wherein a direction of a moved application window relative to the idle window region is opposite the automatic floating direction, for example, first to third windows are arranged from top to bottom, the first window is occupied, the second window is idle, and the third window can be moved upward, where a direction of the third window relative to the second window is downward while the automatic floating direction is upward.

According to some embodiments, the automatic floating direction can be configured for the electronic device. In response to the existence of the idle window region in the at least one window region in the second display region, the application windows displayed in the second display region is caused to move in the automatic floating direction and fill the idle window region in sequence, wherein the direction of the moved window relative to the idle window region is opposite the automatic floating direction. By means of this embodiment, window arrangement can be made compact, and window rearrangement efficiency is improved. For example, referring to a third stage in FIG. 3, the automatic floating direction is configured to be vertically upward, in other words, if the third application window becomes the idle window region after any window region has moved from the third window region 322 and has moved out of the third application window (application window 3), application windows (application windows 4, 5) displayed in other two window regions 323, 324 displayed below the third application window can move upward in the automatic floating direction (vertically upward). The automatic floating direction can be configured in advance; or determined based on an attitude of the electronic device, for example, when it is detected that an upper portion of a terminal device is tilted downward, it is determined that the automatic floating direction is upward, otherwise, the automatic floating direction is downward; or determined based on a preset gesture command.

Specifically, as shown in FIG. 3, in the second stage of FIG. 3, the application window 3 displayed in the window region 322 is removed, and the window region 322 becomes the idle window region. In the third stage of FIG. 3, since the automatic floating direction is vertically upward, the application window 4 previously displayed in the window region 323 below the window region 322 can be moved upward and displayed in the idle window region 322. At this time, since the application window 4 is no longer displayed in the window region 323 and the window region 323 becomes the idle window region, the application window 5 previously displayed in the window region 324 below the window region 323 can be moved upward and displayed in the idle window region 323. Then, the window region 324 becomes the idle window region, and the automatic floating process ends. After the automatic floating process ends, the application window 2, the application window 4 and the application window 5 are displayed in the window regions 321, 322, 323 from top to bottom, respectively, so that the window regions in which the application windows are displayed are very compact and the window rearrangement efficiency is improved.

According to some other embodiments, the automatic floating direction can also be vertically downward.

The above description has been made only by taking the example that the window regions in the second display region are in the vertical arrangement, and it should be understood by those skilled in the art that the present disclosure is not limited thereto. For example, if the windows in the second display region are in a horizontal arrangement, the automatic floating direction can also be horizontally leftward or horizontally rightward.

In such a way, the display of the application windows in the second display region can be made more compact, the window rearrangement efficiency is improved, and the user experience is improved.

According to some embodiments, the method of operating the electronic device can further comprise: in response to removing the third application window from the third window region, running the third application window in the background if the third application window is locked by the task manager of the electronic device; closing the third application window if the third application window is not locked by the task manager of the electronic device.

According to some embodiments, typically, the removal of the third application window means the closing of the third application window. However, the user may not wish to close the third application window with the removal of the third application window. Therefore, the user can lock the third application window through the task manager in advance such that the third application window is locked. After the third application window is locked, it can still run in the background even if the third application window is removed from the first window region due to a window deletion input.

According to other embodiments, the removal of the third application window does not mean the closing of the third application window, but rather causing the third application window to automatically enter the task manager, in other words, running the third application window in the background.

In some cases, when the user wishes to operate an application window displayed in the second display region, an application window displayed in the first display region and the application window displayed in the at least one window region of the second display region can be switched.

In some cases, switching between application windows can comprise switching between positions.

According to some embodiments, the method of operating the electronic device can further comprise: in a state where a fourth application window is being displayed in the first display region, receiving a first window switching input for the fourth application window displayed in the first display region and a fourth window region in the at least one window region displayed in the second display region; and in response to the first window switching input, displaying the fourth application window in the fourth window region.

According to some embodiments, the first window switching input is an input for the fourth application window to be switched and the fourth window region taken as a position to which the fourth application window is to be switched. According to some embodiments, the first window switching input can comprise a clicking input, for example, a double-clicking input for the fourth application window and the fourth window region, respectively, or the like. According to some embodiments, the first window switching input can comprise a sliding input, for example, a sliding input of sliding from the fourth application window to the fourth window region, a sliding input of sliding from the fourth window region to the fourth application window, or the like. According to some embodiments, the first window switching input can further comprise a pressing input, for example, a pressing input of pressing the fourth window region and the fourth application window simultaneously. According to some embodiments, the first window switching input can further comprise a combination of various ways such as the clicking input, sliding input, pressing input, and the like, for example, a combination of a pressing input of pressing the fourth application window and a sliding input of sliding from the fourth application window to the fourth window region.

According to some embodiments, the method of operating the electronic device can further comprise: in response to the first window switching input, displaying a fifth application window in the first display region, wherein the fifth application window was displayed in the fourth window region before the first window switching input has been received.

According to some embodiments, in a case where the fourth window region taken as the position to which the fourth application window is to be switched is not the idle window region, the fifth application window previously displayed in the fourth window region can be caused to be displayed in the first display region. In this way, interchange between positions of the fourth application window previously displayed in the first display region and the fifth application window previously displayed in the second display region can be accomplished. By means of only the first window switching input for the application window to be switched and the window region of the position to which the application window is to be switched, the interchange between the positions of the two application windows can be accomplished, so that the number of operations is greatly reduced, and the user experience is improved.

According to some embodiments, the method of operating the electronic device can further comprise: in a state where a sixth application window is being displayed in a fifth window region in the at least one window region displayed in the second display region, receiving a second window switching input for the fifth window region; and in response to the second window switching input, displaying the sixth application window in the first display region.

According to some embodiments, the second window switching input can comprise a clicking input, for example a clicking input for the second window switching button, a clicking input for the fifth window region, or the like. According to some embodiments, the second window switching input can comprise a pressing input, for example a pressing input for the fifth window region, or the like. In this way, by means of the second window switching input only for the position to which the application window is to be switched, the switching from the application window displayed in the first display region to the at least one window region in the second display region can be accomplished, so that the operation is greatly simplified, and the user experience is improved.

According to some embodiments, the method of operating the electronic device further comprises: in response to the second window switching input, displaying a seventh application window in the fifth window region, wherein the seventh application window was displayed in the first display region before the second window switching input has been received. According to some embodiments, in a case where the fifth window region taken as the position to which the sixth application window is to be switched is not the idle window region, the seventh application window previously displayed in the fifth window region can be caused to be displayed in the first display region. In this way, interchange between positions of the sixth application window previously displayed in the first display region and the seventh application window previously displayed in the second display region can be accomplished. By means of only the second window switching input for the window region of the position to which the application window is to be switched, changes of the positions of the two application windows can be accomplished, so that the operation is further facilitated, and the user experience is improved.

In some cases, the switching between the application windows can also comprise switching between functions.

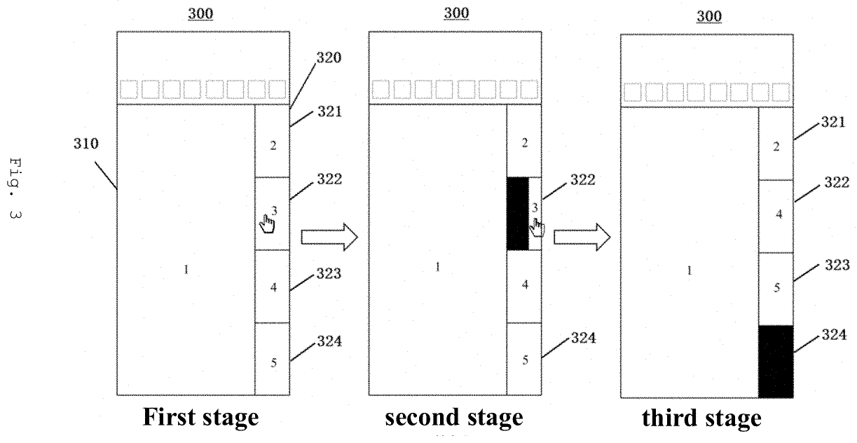

A window switching operation according to an exemplary embodiment of the present disclosure will be described below with reference to FIG. 4. FIG. 4 is a schematic view illustrating switching between an application window displayed in a first display region and an application window displayed in at least one window region of a second display region according to an exemplary embodiment of the present disclosure.

As shown in a first stage in FIG. 4, a user interface 400 of the electronic device comprises a first display region 410 and a second display region 420, wherein the second display region 420 comprises window regions 421, 422, 423, 424. An application window 1 is displayed in the first display region 410, and an application window 2, an application window 3, an application window 4, and an application window 5 are displayed in the four window regions of the second display region 420, respectively.

According to some embodiments, referring to first to second stages in FIG. 4, the method of operating the electronic device can further comprise: in a state where an eighth application window (application window 3) is being displayed in a sixth window region 422 in at least one window region displayed in the second display region 420, receiving an input for the eighth application window (application window 3); and in response to the input for the eighth application window (application window 3), activating the eighth application window, configuring the sixth window region 422 as an updated first display region 410′, and configuring the first display region 410 as an updated window region 422′ in the second display region 420.

The activating the eighth application window can comprise, but is not limited to, any of the following ways:

Way 1, when the eighth application window has been already in an active state, the active state of the eighth window is kept.

Way 2, when the eighth application window is not in the active state, the eighth application window is caused to be the active state.

Way 3, the active state can comprise a plurality of sub-states, for example, a first active state and a second active state, and when a program is in different sub-states, a window of the program can have different functions, for example, when the program is in the first active state, the window of the program can receive a user operation and make feedback, when the program is in the second active state, the window of the program is capable of displaying updated information, or a user-operation set that can be responded to is less than a user-operation set that can be responded to when the program is in the first active state. When the active state comprises the plurality of sub-states, the activating the eighth application window can be to convert the eighth application window from one sub-state to another, for example, from the second active state to the first active state.

According to some embodiments, the first display region and the second display region can be determined according to the active state of the application window and a display position of the application window, for example, a region where the application window in the first active state is located can be determined as the first display region, and a region where the application window in the second active state is located can be determined as the second display region.

According to some embodiments, the input for the eighth application window can comprise a clicking input, a sliding input, a pressing input, a lifting input, or a combination thereof.

According to some embodiments, the sixth window region is a part of the second display region before the sixth window region is configured as the updated first display region. For example, before the sixth window region is configured as the updated first display region, an eighth application window can be displayed in the sixth window region, but the user cannot interact with the eighth application window. By configuring the sixth window region as the updated first display region, the sixth window region is no longer a part of the second display region, but is taken as the updated first display region to replace a previous first display region. Meanwhile, the previous first display region is configured as an updated window region to replace the sixth window region. For example, after the sixth window region is configured as the updated first display region, the user can interact with the eighth application window. In such a way, by means of the input for the eighth application window, the switching between functions of the application windows can be achieved by the user, resulting in less operation steps and better user experience.

In some cases, the switching between the positions of the application windows and the switching between the functions of the application windows can be accomplished simultaneously using a switching animation associated with the window switching.

According to some embodiments, a proportion of the first display region 410 to the user interface 400 of the electronic device can be a first proportion, a proportion of the updated first display region 410′ to the user interface 400 of the electronic device can be the first proportion, a proportion of the sixth window region 422 in the second display region to the user interface 400 of the electronic device can be a second proportion, a proportion of the updated window region 422′ to the user interface 400 of the electronic device can be the second proportion, the first proportion can be greater than the second proportion, and the configuring the sixth window region 422 as the updated first display region 410′ can comprise: zooming in the sixth window region until the proportion of the sixth window region to the user interface of the electronic device increases to the first proportion; and configuring the sixth window region as the updated first display region; and the configuring the first display region 410 as the updated window region 422′ in the second display region can comprise: zooming out the first display region until the proportion of the first display region to the user interface of the electronic device decreases to the second proportion; and configuring the first display region as the updated window region.

According to some embodiments, the proportion of the first display region to the user interface of the electronic device refers to a ratio of a display area of the first display region to a display area of the user interface of the electronic device. The proportion of the updated first display region to the user interface of the electronic device refers to a ratio of a display area of the updated first display region to the display area of the user interface of the electronic device. The proportion of the sixth window region to the user interface of the electronic device refers to a ratio of a display area of the sixth window region to the display area of the user interface of the electronic device. The proportion of the updated window region to the user interface of the electronic device refers to a ratio of a display area of the updated window region to the display area of the user interface of the electronic device. According to some embodiments, the display area of the first display region can be equal to the display area of the updated first display region. In this way, before and after the sixth window region is configured as the updated first display region, the first display region and the updated first display region can remain visually consistent, so that the user's visual experience with respect to the window switching is improved. Similarly, the display area of the sixth window region can be equal to the display area of the updated window region. In this way, before and after the sixth window region is configured as the updated first display region, a total area of the second display region can be kept unchanged to keep the overall layout of the user interface unchanged, which improves the visual experience. In addition, since the display areas of the first display region and the updated first display region are the same and the display areas of the sixth window region and the updated sixth window region are the same, there is no need to define more region sizes, which reduces the layout complexity of the user interface. Moreover, a total display area after the window switching is the same as a total display area before the window switching, so that the display area is not wasted before and after the window switching, which improves the space utilization rate.

According to some embodiments, in a process of zooming in the sixth window region, the eighth application window displayed in the sixth window region can be zoomed in at the same time. According to other embodiments, in the process of zooming in the sixth window region, the eighth application window displayed in the sixth window region is not zoomed in at the same time.

According to some embodiments, referring to the first to second stages of FIG. 4, the first display region 410 can be located on a first side of the user interface 400 of the electronic device, the at least one window region 421, 422, 423, 424 in the second display region can be located on a second side of the user interface of the electronic device, the first side can be opposite the second side, and the method of operating the electronic device can further comprise: in the process of zooming in the sixth window region, causing other window regions 421, 423, 424 other than the sixth window region in the at least one window region in the second display region 420 to move from the second side of the user interface of the electronic device to the first side.

According to some embodiments, for example as shown in FIG. 4, the first side and the second side can refer to a left side and a right side, respectively, of the user interface of the electronic device. Of course, the first side and the second side can also refer to an upper side and a lower side, respectively, of the user interface of the electronic device. In such a way, on the user interface of the electronic device, a region of the sixth window region after being zoomed in to the updated first display region completely covers a region of the sixth window region before being zoomed in, so that a zooming-in animation where the sixth window region is zoomed in remains consistent, which further improves the visual experience of the user. In addition, since the region of the sixth window region after being zoomed in to the updated first display region completely covers the region of the sixth window region before being zoomed in, the input for the eighth application window is always located in the sixth window region or the updated first display region (zoomed-in sixth window region), and after the sixth window region is zoomed in, the user can directly interact with the eighth application window without further movement, so that the movement path is reduced, and the operation is convenient.

According to some embodiments, a second relative position of the updated sixth window region in an updated second display region can be determined according to a first relative position of the sixth window region in the second display region, and preferably, the first relative position and the second relative position are consistent, so that information is more easily positioned by the user and information acquisition efficiency is improved. For example, continuing with the above example of FIG. 4, in the process of zooming in the sixth window region, the other window regions 421, 423, 424 than the sixth window region in the at least one window region in the second display region 420 are caused to move from the second side of the user interface of the electronic device to the first side, and the updated sixth window region is located between the window region 421 and the window region 423.

In some cases, when the user wishes that content in an application window displayed in the first display region can be used in an application window displayed in the second display region, to-be-copied content in the application window displayed in the first display region can be copied to the application window displayed in the at least one window region of the second display region. In some cases, when the user wishes that content in an application window displayed in the first display region can be used in an application window displayed in the second display region, to-be-cut content in the application window displayed in the first display region can be cut and pasted to the application window displayed in the at least one window region of the second display region.

It should be noted that, in this disclosure, a copying operation comprises a cutting operation, the to-be-copied content comprises the to-be-cut content, and a copying input comprises a cutting input.

According to some embodiments, the method of operating the electronic device can further comprise: in a case where a ninth application window is being displayed in the first display region and a tenth application window is being displayed in a seventh window region in the at least one window region in the second display region, receiving a first copying input for to-be-copied content comprised in the ninth application window and the seventh window region; and in response to the first copying input, copying the to-be-copied content into the tenth application window.

According to some embodiments, the first copying input can comprise a clicking input, a sliding input, a pressing input, a lifting input, or a combination thereof.

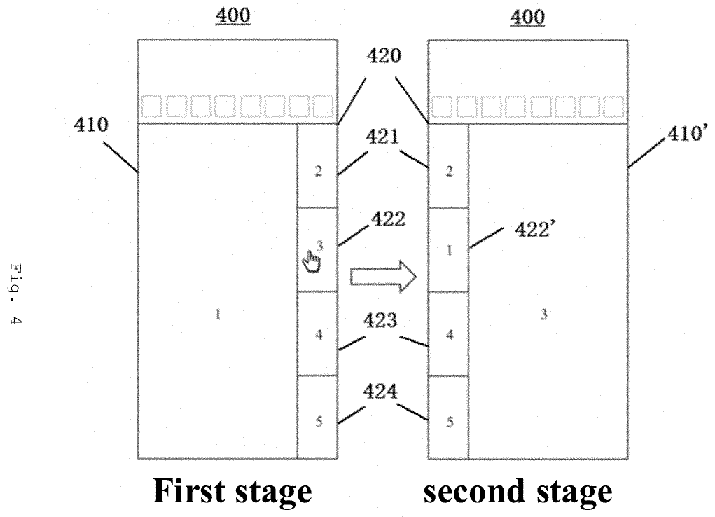

A copying operation according to an exemplary embodiment of the present disclosure will be described below in conjunction with FIG. 5. FIG. 5 is a schematic diagram illustrating copying of to-be-copied content from an application window displayed in a first display region into an application window in at least one window region of a second display region according to an exemplary embodiment of the present disclosure.

As shown in a first stage of FIG. 5, a user interface 500 of the electronic device comprises a first display region 510 and a second display region 520, wherein the second display region 520 comprises window regions 521, 522, 523, 524. An application window 1 is displayed in the first display region 510, and an application window 2, an application window 3, an application window 4, and an application window 5 are displayed in the four window regions of the second display region 520, respectively.

According to some embodiments, referring to first to second stages in FIG. 5, in response to the first copying input, the copying the to-be-copied content 599 into the tenth application window (application window 4) can comprise: in response to the first copying input, selecting the to-be-copied content 599, causing the to-be-copied content 599 to move and to enter the seventh window region 523, causing the to-be-copied content 599 to stay at the seventh window region 523, copying the to-be-copied content 599 into the tenth application window (application window 4) displayed in the seventh window region 523.

According to some embodiments, the first copying input can comprise a first portion, a second portion, a third portion, and a fourth portion. For example, the first portion of the first copying input can comprise a pressing input for the to-be-copied content, the second portion of the first copying input can comprise a sliding input for the to-be-copied content, the third portion of the first copying input can comprise a staying input for the seventh window region, and the fourth portion of the first copying input can comprise a lifting input for the to-be-copied content.

According to some embodiments, in response to the first portion (for example, the pressing input) of the first copying input, the to-be-copied content is selected, which indicates that the user wishes to perform a further operation for the to-be-copied content.

According to some embodiments, in response to the second portion (for example, the sliding input) of the first copying input, the to-be-copied content is caused to move and to enter the seventh window region. For example, the to-be-copied content is caused to follow the sliding input of the user on the user interface to move.

According to some embodiments, in response to the third portion (for example, the staying input) of the first copying input, the to-be-copied content is caused to stay at the seventh window region, which indicates that a target position to which the user wishes to copy the to-be-copied content is the tenth application window displayed in the seventh window region.

According to some embodiments, in response to the fourth portion (for example, the lifting input) of the first copying input, the to-be-copied content is copied into the tenth application window displayed in the seventh window region, and the copying operation is completed.

According to some embodiments, referring to second to third stages in FIG. 5, in response to the first copying input, the causing the to-be-copied content 599 to stay at the seventh window region can comprise: comparing a staying time of the to-be-copied content 599 at the seventh window region 523 with a first threshold time; and if the staying time is greater than the first threshold time, activating the tenth application window.

Throughout this disclosure, “an application window is active” refers to allowing the user to interact with the application window, and “an application window is inactive” refers to not allowing the user to interact with the application window.

According to some embodiments, the activating the tenth application window can comprise transferring a focus label from the ninth application window to the tenth application window. Of course, the present disclosure is not limited to activating an application window by transferring the focus label, and the activation of the application window can also be accomplished using any other suitable technique.

According to some embodiments, if the staying time is greater than the first threshold time, the method can further comprise: configuring the seventh window region 523 as an updated first display region 510′ and displaying, in the first display region 510, the tenth application window (application window 4), and configuring the first display region 510 as an updated window region 523′ and displaying, in the updated window region 523′, the ninth application window (application window 1).

According to some embodiments, the staying time of the third portion (for example, the staying input) of the first copying input at the seventh window region can be compared with the first threshold time. It should be noted that the staying input described herein does not require that it must stay at a fixed position, and the staying input can be in a small movement within a range not going beyond the seventh window region. Similarly, the staying time described herein does not necessarily specially refer to a duration in which the position of the third portion of the first copying input on the user interface does not change, and the staying time can also refer to a duration in which the third portion of the first copying input is in the seventh window region.

According to some embodiments, the first threshold time can be 0.5 second, 1 second, 1.5 seconds, 2 seconds, 3 seconds, or the like.

According to some embodiments, the seventh window region is part of the second display region before the seventh window region is configured as the updated first display region. For example, before the seventh window region is configured as the updated first display region, the tenth application window can be displayed in the seventh window region, but the user cannot interact with the tenth application window. By configuring the seventh window region as the updated first display region, the seventh window region is no longer part of the second display region but is taken as the updated first display region to replace the previous first display region. Meanwhile, the previous first display region is configured as the updated window region to replace the seventh window region. For example, the user can interact with the tenth application window after the seventh window region is configured as the updated first display region.

According to some embodiments, after the tenth application window is displayed in the first display region, the to-be-copied content is copied into the tenth application window in response to the fourth portion (for example, the lifting input) of the first copying input. A purpose of the user copying the to-be-copied content in the current application window to another application window is generally to use the to-be-copied content in the other application window. According to an exemplary embodiment of the present disclosure, by the first copying input, the user can not only copy the to-be-copied content to the other application window, but also display the other application window in the first display region at the same time, which greatly facilitates a subsequent operation of the user.

In such a way, the user can accomplish the copying of the to-be-copied content for the first copy input and simultaneously accomplish the display of the application window taken as the copying target, for a further operation of the user, so that the operation of the user is greatly simplified, and the user experience is improved.

According to some embodiments, a proportion of the first display region 510 and the updated first display region 510′ to the user interface 500 of the electronic device can be the first proportion, a proportion of the seventh window region 523 in the second display region 520 and the updated window region 523′ to the user interface 500 of the electronic device can be the second proportion, the first proportion can be greater than the second proportion, and the configuring the seventh window region 523 as the updated first display region 510′ can comprise: zooming in the seventh window region until the proportion of the seventh window region to the user interface of the electronic device increases to the first proportion; and configuring the seventh window region as the updated first display region, so that it has all of the functions associated with the user interface of the electronic device; and the configuring the first display region 510 as the updated window region 523′ in the second display region can comprise: zooming out the first display region until the proportion of the first display region to the user interface of the electronic device decreases to the second proportion; and configuring the first display region as the updated window region, so that it has some of the functions associated with the user interface of the electronic device.

According to some embodiments, the proportion of the first display region to the user interface of the electronic device refers to a ratio of a display area of the first display region to a display area of the user interface of the electronic device. The proportion of the updated first display region to the user interface of the electronic device refers to a ratio of a display area of the updated first display region to the display area of the user interface of the electronic device. The proportion of the seventh window region to the user interface of the electronic device refers to a ratio of a display area of the seventh window region to the display area of the user interface of the electronic device. The proportion of the updated window region to the user interface of the electronic device refers to a ratio of a display area of the updated window region to the display area of the user interface of the electronic device. According to some embodiments, the display area of the first display region can be equal to the display area of the updated first display region. In this way, before and after the seventh window region is configured as the updated first display region, the first display region and the updated first display region can be visually consistent, which improves the visual experience. Similarly, the display area of the seventh window region can be equal to the display area of the updated window region. In this way, before and after the seventh window region is configured as the updated first display region, a total area of the second display region can be kept unchanged to keep the overall layout of the user interface unchanged, which improves the visual experience. In addition, since the display areas of the first display region and the updated first display region are the same and the display areas of the seventh window region and the updated seventh window region are the same, there is no need to define more region sizes, which reduces the layout complexity of the user interface. Moreover, a total display area after the window switching is the same as a total display area before the window switching, and the display area is not wasted before and after the window switching, which improves the space utilization rate.

According to some embodiments, referring to second to third stages in FIG. 5, the first display region 510 can be located on a first side of the user interface 500 of the electronic device, the at least one window region 523 in the second display region can be located on a second side of the user interface 500 of the electronic device, the first side can be opposite the second side, and the method of operating the electronic device can further comprise: as the seventh window region 523 is zoomed in, causing other window regions 521, 522, 524 than the seventh window region in the at least one window region in the second display region 520 to move from the second side of the user interface of the electronic device to the first side.

According to some embodiments, the first side and the second side can refer to a left side and a right side, respectively, of the user interface of the electronic device. Of course, the first side and the second side can also refer to an upper side and a lower side, respectively, of the user interface of the electronic device. In such a way, on the user interface of the electronic device, a region of the seventh window region after being zoomed in to the updated first display region completely covers a region of the seventh window region before being zoomed in, so that a zooming-in animation where the seventh window region is zoomed in remains consistent, which further improves the visual experience of the user. In addition, since the region of the seventh window region after being zoomed in to the updated first display region completely covers the region of the seventh window region before being zoomed in, the input for the eighth application window is always located in the seventh window region or the updated first display region (the zoomed-in seventh window region), and the user can directly interact with the eighth application window without further movement after the seventh window region is zoomed in, so that the movement path is reduced, and the operation is convenient.

According to some embodiments, a position of causing the to-be-copied content to stay at the seventh window region can be a staying position, and after the seventh window region is configured as the updated first display region and the first display region is configured as the updated window region, the staying position can be located in the tenth application window displayed in the updated first display region.

According to some embodiments, since the region of the updated first display region completely covers the region of the seventh window region, in response to the third portion (for example, the staying input) of the first copying input, the to-be-copied content is located directly in the updated first display region after the seventh window region is zoomed in. At this time, the user can directly perform the fourth portion (for example, the lifting input) of the first copying input without the need of performing an additional sliding input (for example, a sliding input for the to-be-copied content), and can copy the to-be-copied content into the tenth application window in the updated first display region, which reduces the movement path of the first copying input. This further improves the user experience when performing the copying operation.

According to an example and referring to FIG. 5, a “hollow circle” represents the to-be-copied content 599, and a gesture represents a position of the first copying input on the user interface of the electronic device.

Referring to the first stage of FIG. 5, the first display region 510 is located on the left side of the user interface. The second display region comprises the window regions 521, 522, 523, 524, which are located on the right side of the graphical user interface, wherein the window region represented by the window region 523 is a window region to which the to-be-copied content is to be copied. In the first stage of FIG. 5, the to-be-copied content 599 is selected in response to the first portion (a pressing input for the to-be-copied content 599) of the first copying input.

Referring to the second stage of FIG. 5, the to-be-copied content is caused to move into the window region 523 in response to the second portion (a sliding operation for the to-be-copied content) of the first copying input.

Referring to the third stage of FIG. 5, in response to the third portion (the staying input) of the first copying input, for example, staying in the window region 523 for 2 seconds, the window region 523 is zoomed in. A display area of the zoomed-in window region 510′ is the same as a display area of the first display region 510 illustrated in the first stage or the second stage with reference to FIG. 5. Meanwhile, the first display region 510 illustrated in the first or second stage with reference to FIG. 5 is zoomed out, a display area of the zoomed-out first display region 523′ is the same as a display area of the window region 523 illustrated in the first or second stage with reference to FIG. 5.

Still referring to the third stage of FIG. 5, in response to the third portion (the staying input) of the first copying input, the window regions 521, 522, 524 move from the right side of the user interface to the left side of the user interface. Such a display mode has the following advantages:

first, the zoomed-in window region 510′ completely covers the window region 523 before the zooming-in, so that after the second portion of the first copying input, the to-be-copied content 599 is always in the window region 523 and the zoomed-in window region 510′. Before the fourth portion (the lifting input) of the first copying input is executed, there is no longer the need to cause the to-be-copied content to move, which reduces the movement path and makes the copying operation simpler and more convenient.

Second, the zoomed-in window region 510′ completely covers the window region 523 before the zooming-in, so that the zooming-in animation of the window region 523 goes continuously, which improves the visual experience of the user.

In addition, the first display region 510 before the zooming-out completely covers the zoomed-out first display region 523′, so that the zooming-out animation of the first display region 510 goes continuously, which improves the visual experience of the user.

According to some embodiments, the tenth application window can comprise at least one application internal control corresponding to at least one sub-window, and the causing the to-be-copied content to stay at the seventh window region can comprise: causing the to-be-copied content to stay at the seventh window region, causing the to-be-copied content to move to a first application internal control in the at least one application internal control in the tenth application window displayed in the updated first display region, and copying the to-be-copied content into a first sub-window corresponding to the first application internal control.

Hereinafter, the sub-window refers to a sub-window of an application window.

Hereinafter, the application internal control refers to a region that is displayed within an application window and corresponds to a sub-window that can, for the application internal control, be opened within the application window.

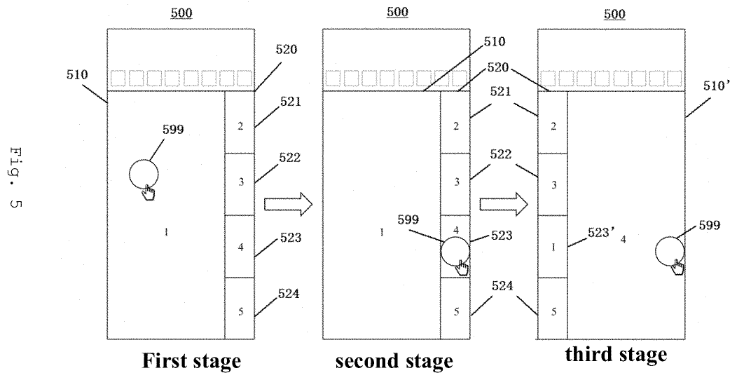

An exemplary embodiment according to the present disclosure will be described in detail below with reference to FIG. 6. FIG. 6 is a schematic diagram illustrating copying of to-be-copied content from an application window displayed in a first display region into a chat tool application window in at least one window region of a second display region according to an exemplary embodiment of the present disclosure.

As shown in a first stage of FIG. 6, a user interface 600 of the electronic device comprises a first display region 610 and a second display region 620, wherein the second display region 620 comprises window regions 621, 622, 623, 624. A folder application window is displayed in the first display region 610 and the chat tool application window is displayed in the window region 621 of the second display region 620.

According to some embodiments, the application internal control 650 can have a button shape. According to other embodiments, the application internal control can have a non-button shape, for example, as shown in FIG. 6, each contact in a contact list can be one application internal control 650 in the chat tool application window. In response to an input for one contact A in the contact list, a sub-window corresponding to the contact A can be opened within the application window.

According to some embodiments, if the tenth application window further comprises the first application internal control corresponding to the first sub-window, the third portion of the first copying input can comprise a staying input and a sliding input. In response to a sliding input in the fourth portion of the first copying input, the to-be-copied content can be caused to move from a staying position to the first application internal control. After causing the to-be-copied content to move to the first application internal control, in response to the fourth portion (lifting input) of the first copying input, the to-be-copied content can be copied into a first sub-window in the tenth application window, which corresponds to the first application internal control.

In such a way, by means of the first copying input, the to-be-copied content in one application window can be copied into the sub-window in the other application window, so that the operation is greatly simplified, and the user experience is improved.

According to one example and referring to FIG. 6, the user wishes to copy a pdf file 699 named “d3” in the folder application window displayed in the first display region 610 to a contact “Xiao Ming” in a contact list of another application window (chat tool application window, for example, Lark) displayed in one window region 621 of the second display region 620. It should be noted that first to second stages shown in FIG. 6 (i.e., operations when and before the chat tool application window is zoomed in) are consistent with the first to third stages in the example described with reference to FIG. 5. Referring to a third stage of FIG. 6, after the chat tool application window is zoomed in, the pdf file 699 is moved to the application internal control 650 representing the contact “Xiao Ming”. At this time, in response to the lifting input, the pdf file 699 can be copied into a session sub-window that corresponds to the application internal control 650 representing the contact “Xiao Ming” which is used for taking a session with the contact “Xiao Ming”.

According to some embodiments, the copying the to-be-copied content into the first sub-window corresponding to the first application internal control can comprise: causing the to-be-copied content to stay at the first application internal control, displaying the first sub-window, and copying the to-be-copied content into the first sub-window corresponding to the first application internal control.

According to some embodiments, the user not only wishes to copy the to-be-copied content to the first sub-window of the tenth application window, but also wishes to further open the first sub-window. For example, the user may wish to further edit the to-be-copied content in the first sub-window. At this time, the third portion of the first copying input can comprise a first staying input, a sliding input, and a second staying input. The first staying input in the third portion of the first copying input is the same as the staying input in the third portion of the first copying input described above in conjunction with the exemplary embodiment. The sliding input in the third portion of the first copying input is the same as the sliding input in the third portion of the first copying input described above in conjunction with the exemplary embodiment. The second staying input in the third portion of the first copying input comprises a staying input for the first application internal control. In response to the second staying input in the third portion of the first copying input, the first sub-window in the tenth application window is displayed in the updated first display region. Then, in response to the fourth portion (for example, the lifting input) of the first copying input, the to-be-copied content is copied into the first sub-window displayed in the first display region.

In such a way, by the first copying input, the to-be-copied content in the one application window can be copied into the sub-window in the other application window, and at the same time, the sub-window is opened for a subsequent operation of the user, so that the operation is further simplified, and the user experience is improved.

According to some embodiments, the to-be-copied content according to the present disclosure can be any content suitable for copying. According to some embodiments, the to-be-copied content can comprise at least one of text, note, document, image, audio, or video.

According to some embodiments, the partition result can further comprise a file display region 630, and the method of operating the electronic device can further comprise: displaying at least one file in the file display region 630. According to some embodiments, the at least one file comprises at least one of text, note, document, image, audio or video.

According to some embodiments, a thumbnail of the at least one file can be displayed in the file display region. According to some embodiments, the electronic device can categorize the at least one file into for example text, note, document, image, audio, video, or the like. According to some embodiments, the electronic device can assign category identification information (for example, icon, button, view control, or the like) to each category. For example, at least one of a text category icon, a note text category icon, a document text category icon, an image text category icon, an audio text category icon, or a video text category icon can be displayed in the file display region.

According to some embodiments, in response to a user input (for example, a clicking input, a pressing input, or the like) for any of the category icons described above, a corresponding category menu (for example, a video category menu) can be displayed, in which files belonging to the category are comprised.

According to some embodiments, the file display region is part of the user interface of the electronic device. According to some embodiments, the file display region does not overlap with the first display region and does not overlap with the second display region. According to some embodiments, the file display region can overlap with the first display region or with the second display region.

According to some embodiments, as shown in FIG. 6, the file display region is displayed between boundaries of the first display region and the user interface of the electronic device. In such a way, the file display region does not overlap with the first display region on the user interface of the electronic device, which prevents a mistaken touch operation when the file display region is in interaction with the first display region or the second display region and reduces the layout complexity of the user interface.

According to some embodiments, the at least one file displayed in the file display region can be defaulted by the system. According to some embodiments, the at least one file displayed in the file display region can be set by the user. According to some embodiments, the at least one file displayed in the file display region can be a historical operation file.

According to some embodiments, the method of operating the electronic device can further comprise: receiving a second copying input for a first file in the at least one file and a target application window displayed in the first display region or one arbitrary window region in the at least one window region displayed in the second display region; and in response to the second copying input, copying the first file into the target application window for calling by the target application window.

According to some embodiments, the second copying input can comprise a clicking input, a pressing input, a sliding input, a staying input, a lifting input, or a combination thereof.

In such a way, by means of the second copying input, the user can directly copy a historical file, a common file set by the user, a common file defaulted by the system, and the like to the target application window in the first display region for a subsequent operation of the user, so that the operation is greatly simplified, and the user experience is improved. In addition, by means of the second copying input, the user can also directly copy the historical file, the common file set by the user, the common file defaulted by the system, and the like to the target application window in the one arbitrary window region in the second display region for subsequent viewing or reference by the user, so that the operation is greatly simplified, and the user experience is improved.

According to some embodiments, the in response to the second copying input, copying the second file into the target application window in the one arbitrary window region can further comprise: in response to the second copying input, selecting the second file, causing the second file to move and to enter the one arbitrary window region, causing the second file to stay at the target application window in the one arbitrary window region, and copying the second file into the target application window in the one arbitrary window region.

According to some embodiments, the second copying input can comprise a first portion, a second portion, a third portion, and a fourth portion. For example, the first portion of the second copying input can comprise a pressing input for the second file, the second portion of the second copying input can comprise a sliding input for the second file, the third portion of the second copying input can comprise a staying input for the one arbitrary window region, and the fourth portion of the second copying input can comprise a lifting input for the second file.

According to some embodiments, in response to the first portion (for example, the pressing input) of the second copying input, the second file is selected, which indicates that the user wishes to perform a further operation for the second file.

According to some embodiments, in response to the second portion (for example, the sliding input) of the second copying input, the second file is caused to move and to enter the one arbitrary window region. For example, the second file is caused to follow the sliding input by the user on the user interface to move.

According to some embodiments, in response to the third portion (for example, the staying input) of the second copying input, the second file is caused to stay at the one arbitrary window region, which indicates that a target position to which the user wishes to copy the second file is the target application window displayed in the one arbitrary window region.

According to some embodiments, in response to the fourth portion (for example, the lifting input) of the second copying input, the second file is copied in the target application window displayed in the one arbitrary window region, and the copying operation is completed.

In such a way, by the second copying input, the user can directly copy the historical file, the common file set by the user, the common file defaulted by the system, and the like to the target application window in the one arbitrary window region in the second display region for subsequent viewing or reference by the user, so that the operation is greatly simplified, and the user experience is improved.

According to some embodiments, the causing the second file to stay at the one arbitrary window region can comprise: comparing a staying time of the second file at the one arbitrary window region with a second threshold time; and if the staying time is greater than the second threshold time, configuring the one arbitrary window region as an updated first display region, and configuring the first display region as an updated window region.

According to some embodiments, the second threshold time can be 0.5 second, 1 second, 1.5 seconds, 2 seconds, 3 seconds, or the like.

According to some embodiments, the one arbitrary window region is part of the second display region before the one arbitrary window region is configured as the updated first display region. For example, before the one arbitrary window region is configured as the updated first display region, the target application window can be displayed in the one arbitrary window region, but the user cannot interact with the target application window. By configuring the one arbitrary window region as the updated first display region, the one arbitrary window region is no longer part of the second display region, but is taken as the updated first display region to replace the previous first display region. Meanwhile, the previous first display region is configured as the updated window region to replace the one arbitrary window region. For example, the user can interact with the target application window after the one arbitrary window region is configured as the updated first display region.

According to some embodiments, in response to the fourth portion (for example, the lifting input) of the second copying input, the second file is copied into the target application window in the one arbitrary window region. A purpose of the user copying the second file to the target application window is typically to use the second file in the target application window. According to an exemplary embodiment of the present disclosure, by means of the second copying input, the user can not only copy the second file to the target application window, but also display the target application window in the first display region at the same time, which greatly facilitates a subsequent operation of the user.

According to some embodiments, the partition result further comprises an application icon display region 640, and the method of operating the electronic device can further comprise: displaying at least one application icon in the application icon display region 640.

According to some embodiments, the application icon display region is part of the user interface of the electronic device. According to some embodiments, the application icon display region does not overlap with the first display region, the second display region, and the file display region. According to some embodiments, the application icon display region can overlap with the first display region or the second display region or the file display region. According to some embodiments, the application icon display region can be displayed in the same region in the user interface of the electronic device as the file display region, such as an upper side, lower side, left side, right side, middle, or the like of the user interface.

According to some embodiments, as shown in FIG. 6, the application icon display region is displayed between boundaries of the first display region and the user interface of the electronic device. In such a way, on the user interface of the electronic device, the application icon display region does not overlap with the first display region and does not overlap with the second display region, which prevents a mistaken touch operation when the application icon display region is in interaction with the first display region or the second display region and reduces the layout complexity of the user interface.

According to some embodiments, the at least one application icon displayed in the application icon display region can be defaulted by the system. According to some embodiments, the at least one application icon displayed in the application icon display region can be set by the user. According to some embodiments, the at least one application icon displayed in the application icon display region can be a historical operation application icon.

According to some embodiments, the method of operating the electronic device can further comprise: receiving a first opening input for a first application icon of the at least one application icon; and in response to the first opening input, displaying an application window corresponding to the first application icon in the first display region.

According to some embodiments, the first opening input can be a clicking input for the first application icon. In response to the clicking input, the application window corresponding to the first application icon can be opened in the first display region.

In such a way, by means of the first opening input, the application window corresponding to the application icon in the application icon display region can be opened into the first display region for subsequent operation for the application window by the user, so that the operation is simple and convenient, and the user experience is good.

According to some embodiments, the method of operating the electronic device can further comprise: receiving a second opening input for a second application icon of the at least one application icon and one arbitrary window region in the at least one window region; and in response to the second opening input, displaying an application window corresponding to the second application icon in the one arbitrary window region.

According to a first embodiment, the second opening input can be a combination of a single-clicking input for the second application icon and a single-clicking input for the one arbitrary window region in the at least one window region. In response to the two clicking inputs for the second application icon and the one arbitrary window region, respectively, the application window corresponding to the second application icon can be opened in the one arbitrary window region.

In such a way, by means of the second opening input, the application window corresponding to the application icon in the application icon display region can be opened into the second display region for subsequent viewing or reference by the user, so that the operation is simple and convenient, and the user experience is good.

According to some embodiments, each window region in the at least one window region displayed in the second display region can be configured to be capable of displaying the application window in real time. According to some embodiments, being capable of displaying in real time means being capable of running in a foreground. In other words, according to some embodiments, the window region configured to be capable of displaying the application window in real time can also be configured to be capable of running the application window in the foreground.

In such a way, the application window displayed in the at least one window region displayed in the second display region can display content in the application window in real time, which is convenient for the user to view.

According to some embodiments, the application window displayed in the first display region is in foreground running, and the application window displayed in the at least one window region of the second display region can also be in foreground running.

According to some embodiments, an application window displayed in the first display region is active, and an application window displayed in each window region in the at least one window region displayed in the second display region can be inactive.

According to some embodiments, the application window displayed in the first display region can be active, and the application window displayed in each window region in the at least one window region displayed in the second display region can be active.

Throughout this disclosure, “an application window is active” refers to allowing the user to interact with the application window, and “an application window is inactive” refers to not allowing the user to interact with the application window.

In some cases, for example, in a system such as android, two or more application windows may not be allowed to be activated at the same time. For example, in a case where a plurality of application windows are in foreground running at the same time, the system may only allow one of the application windows to be activated, while other application windows are suspended or frozen.

The following description of how to make an application window become inactive or active will be made below by taking a focus-label transferor no notification technique as an example. Of course, the present disclosure is not limited to the focus label technique to cause the application window to switch between an active state and an inactive state, and it should be understood by those skilled in the art that any technique enabling the application window to switch between the active state and the inactive state can be used in the present disclosure and is within the scope of the present disclosure.

According to some embodiments, by transferring the focus label from a fourteenth application window to a fifteenth application window, the fifteenth application window can be activated.

According to some embodiments, the fourteenth application window can be kept active by not notifying the fourteenth application window that the focus label has been transferred.

In these cases, according to some embodiments, the method can further comprise: displaying the fourteenth application window on the user interface, and sending the focus label to the fourteenth application window; displaying the fifteenth application window in the user interface in response to the first window creation input (as has been described in detail above); receiving a focus transfer request; and transferring the focus label from the fourteenth application window to the fifteenth application window based on the focus transfer request, and at the same time not notifying the fourteenth application window that the focus label has been transferred.

According to some embodiments, when the electronic device has detected the first window creation input, typically, the focus label is transferred to a new application window (i.e., the fifteenth application window), i.e., focus transfer is performed. Typically, the focus label is used to determine whether an application window is active or inactive. According to some examples, an application window with the focus label can be active, such as interacting (dragging, playing) with the user, and the like. Typically, although an application window without the focus label has already been created (for example, displayed) on the user interface but is not inactive, the application window can kept active by not notifying the application window that the focus label has been transferred.

According to some embodiments, while the fourteenth application window is running in the foreground, at least one fifteenth application window can also be created. According to some examples, new application windows can be created in response to a plurality of the first window creation inputs. For example, while the fourteenth application window is running in the foreground, the fifteenth application window is created and at the same time the focus label is transferred from the fourteenth application window to the fifteenth application window. At this time, if the fourteenth application window is notified that it no longer has the focus label, the foreground running of the fourteenth application window is suspended or frozen. However, if only the focus label is transferred without notifying the fourteenth application window that the focus label has been transferred, the fourteenth application window also continues foreground running according to the state of having the focus label, that is, the foreground running of the fourteenth application window is not affected. On the other hand, the fifteenth application window receives the focus label, and the fifteenth application window runs in the foreground according to the state of having the focus label. At this time, both the fourteenth application window and the fifteenth application window run in the foreground according to the state of having the focus label. Thereafter, when more new application windows are created, the focus label is sequentially transferred according to a creation order of the new application windows while an application window to which the focus label has been previously transferred also does not receive the notification that the focus label has been transferred (i.e., not having the focus label) and still runs in the foreground. Therefore, the fourteenth application window, the fourteenth application or more new application windows on the user interface can be caused to run in the foreground at the same time.

According to some embodiments, the fourteenth application window can be displayed in the first display region of the user interface, and the fifteenth application window can be displayed in any window region in the second display region of the user interface. According to some other embodiments, the fourteenth application window can be displayed in any window region in the second display region of the user interface, and the fifteenth application window can be displayed in the first display region. According to still other embodiments, the fourteenth application window and the fifteenth application window can be simultaneously displayed in any two window regions in the second display region of the user interface.

In such a way, for example, the fourteenth application window is a video playing application window that is playing a movie. The fifteenth application window is a chat tool application window. After the chat tool application window is created on the user interface, the focus label is transferred from the video playing application window to the chat tool application window. Meanwhile, although the focus label has been transferred from the video playing application window, the video playing application window does not receive the notification that the focus label has been transferred, and still runs in the foreground according to the state of having the focus label and therefore can still continue playing the movie, which improves the use efficiency of the user interface.

According to some embodiments, an aspect ratio of the first display region can be equal to an aspect ratio of the user interface of the electronic device.

In such a way, any content is zoomed in equal proportion when it is displayed in the first display region and when it is displayed on the user interface of the electronic device. In this way, the same content will not visually deformed due to being displayed on the entire user interface and being displayed on the first display region that is part of the user interface, which improves the visual experience of the user. In addition, the zooming in equal proportion can keep the content previously displayed on the user interface not deformed when it is displayed in the first display region, without rearranging the user interface, so that the layout complexity is reduced, and since there is no need to change the aspect ratio of the display control, the consumption of system resources is reduced.

According to some embodiments, the partition display input can be a sliding input, and in response to the partition display input, the partitioning the user interface of the electronic device and displaying the partition result can further comprise: detecting a sliding direction of the partition display input; determining a third direction based on the sliding direction of the partition display input; zooming out the user interface of the electronic device in such a way that a center of the user interface of the electronic device moves in the third direction, wherein the aspect ratio of the user interface of the electronic device remains unchanged in a process of zooming out the user interface of the electronic device; and configuring the zoomed-out user interface of the electronic device as the first display region.

According to some embodiments, the third direction can be a direction along a diagonal of the user interface of the electronic device. According to some embodiments, the third direction can be a direction toward the upper left along an upper left-lower right diagonal of the user interface, can be a direction toward the lower right along an upper left-lower right diagonal of the user interface, can be a direction toward the upper right along an upper right-lower left diagonal of the user interface, or can be a direction toward the lower left along an upper right-lower left diagonal of the user interface. In such a way, when the user interface of the electronic device is zoomed out in such a way that the center of the user interface of the electronic device moves in the third direction (the above four diagonal directions), the aspect ratio of the user interface of the electronic device can remain unchanged in a zooming-out process.

According to some embodiments, the determining a third direction based on the sliding direction of the partition display input (for example, the sliding input) can comprise: determining comprised angles between the sliding direction and the above four diagonal directions, respectively; and determining a diagonal direction corresponding to a minimum comprised angle among the determined four comprised angles as the third direction.

According to some embodiments, the configuring the zoomed-out user interface of the electronic device as the first display region means that all content displayed on the user interface of the electronic device will continue to be displayed in the configured first display region and that the first display region has all of the functions associated with the user interface of the electronic device.

According to some embodiments, the in response to the partition display input, partitioning the user interface of the electronic device and displaying the partition result can further comprise: detecting an input distance of the partition display input; and determining a zooming-out proportion of the user interface of the electronic device based on the input distance.

According to some embodiments, the greater the input distance (sliding distance) of the partition display input (sliding input), the greater the zooming-out proportion of the user interface of the electronic device.

In such a way, by means of the partition display input, not only can the user interface of the electronic device be partitioned, but also the desired zooming-out proportion can be adjusted in an input process, to determine the display area of the first display region after responding to the partition display input.

According to some embodiments, the second display region can comprise a predetermined-number of window regions, a width and a height of each window region in the four window regions can be identical with each other, a sum of a width of the first display region and a width of the second display region can be equal to a width of the user interface of the electronic device, and a height of the first display region can be equal to predetermined-number times the height of each window region.

According to some embodiments, the predetermined-number of window regions can be arbitrary-integer windows, such as one window region, two window regions, three window regions, four window regions, five window regions, and so on. Taking an example that the second display region comprises four window regions and referring to FIGS. 2A to 6, the second display region has four window regions with the same display area and is located on the left or right side of the user interface of the electronic device. In such a way, the user interface after responding to the partition display input is caused more aesthetically pleasing. In addition, this causes an aspect ratio of each window region in the second display region to be the same as that of the first display region (i.e., the same as that of the user interface of the electronic device), which ensures that the same content will not be visually deformed due to being displayed on the first display region and being displayed on the second display region and improves the visual experience of the user.

According to a second aspect of the present disclosure, there is provided a method of operating an electronic device, wherein a user interface of the electronic device can comprise a first display region and a second display region, the second display region comprising at least one window region, a thirteenth application window being displayed in an eighth window region of the at least one window region in the second display region, the method comprising: receiving a switching input for the thirteenth application window; and in response to the switching input, activating the thirteenth application window, configuring the eighth window region as an updated first display region, and configuring the first display region as an updated eighth window region. According to some embodiments, before the switching input has been received, a twelfth application window is displayed in the first display region, and the method can further comprise: in response to the switching input, displaying the thirteenth application window in the updated first display region and displaying the twelfth application window in the updated eighth window region.

Receiving a switching input for a window region in the second display region, for example, receiving the switching input for the thirteenth application window, can comprise, but is not limited to, any of the following: having received a preset switching command such as a clicking command, a pressing command or a voice command for a switched window region (for example, the eighth window region); or, having received a copying command to copy content to the switched application window; or, having received a command to exchange positions of the first display region and the second display region, for example, when a terminal has detected that an application window of the first display region has been dragged into the window region in the second display region, the terminal can judge that the command to interchange the positions of the first display region and the second display region has been detected.

A second aspect of the present disclosure will be described below with reference to FIG. 4. As shown in a first stage in FIG. 4, a user interface 400 of the electronic device comprises a first display region 410 and a second display region 420, wherein the second display region 420 comprises window regions 421, 422, 423, 424. An application window 1 is displayed in the first display region 410, and an application window 2, an application window 3, an application window 4, and an application window 5 are displayed in the four window regions of the second display region 420, respectively.

According to some embodiments, referring to first to second stages in FIG. 4, the method of operating the electronic device can further comprise: in a state where a thirteenth application window (application window 3) is being displayed in an eighth window region 422 in at least one window region displayed in the second display region 420, receiving an input for the thirteenth application window (application window 3); and in response to the input for the thirteenth application window (application window 3), activating the thirteenth application window, configuring the eighth window region 422 as an updated first display region 410′, and configuring the first display region 410 as an updated eighth window region 422′ in the second display region 420.

According to some embodiments, the switching input for the thirteenth application window can comprise a clicking input, a sliding input, a pressing input, a lifting input, or a combination thereof.

It should be noted that the switching input for the thirteenth application window, which is described herein in conjunction with the second aspect of the present disclosure, encompasses all the functions, as described in detail in conjunction with the first aspect of the present disclosure, of the input for the eighth application window, for example, clicking a window, copying content to the window, dragging a window of the first display region to the window of the second display region, and so on.

According to some embodiments, before the eighth window region is configured as the updated first display region, the eighth window region is part of the second display region. For example, before the eighth window region is configured as the updated first display region, the thirteenth application window can be displayed in the eighth window region, but the user cannot interact with the thirteenth application window. By configuring the eighth window region as the updated first display region, the eighth window region is no longer part of the second display region, but is taken as the updated first display region to replace the previous first display region. Meanwhile, the previous first display region is configured as an updated eighth window region to replace the eighth window region. For example, after the eighth window region is configured as the updated first display region, the user can interact with the thirteenth application window. In such a way, by means of the input for the thirteenth application window, the user can achieve the function switching of the application window, resulting in less operation steps and better user experience.

According to some embodiments, the updated first display region covers the eighth window region.

In such a way, on the user interface of the electronic device, since a region of the eighth window region after being zoomed in to the updated first display region completely covers a region of the eighth window region before being zoomed in, the input for the thirteenth application window is always located in the eighth window region or the updated first display region (the zoomed-in eighth window region), and the user can directly interact with the thirteenth application window without further movement after the eighth window region is zoomed in, so that the movement path is removed, and the operation is convenient. In addition, the region of the eighth window region after being zoomed in to the updated first display region completely covers the region of the eighth window region before being zoomed in, so that a zooming-in animation where the eighth window region is zoomed in remains consistent, and the visual experience of the user is further improved.

According to some embodiments, a proportion of the first display region to the user interface of the electronic device is a first proportion, a proportion of each window region in the at least one window region in the second display region to the user interface of the electronic device is a second proportion, the first proportion is greater than the second proportion, and the method further comprises: in response to the switching input, zooming in the eighth window region until a proportion of the eighth window region to the user interface of the electronic device increases to the first proportion, and zooming out the first display region until the proportion of the first display region to the user interface of the electronic device decreases to the second proportion.

According to some embodiments, a proportion of the first display region 410 to the user interface 400 of the electronic device can be the first proportion, a proportion of the updated first display region 410′ to the user interface 400 of the electronic device can be the first proportion, a proportion of the eighth window region 422 in the second display region to the user interface 400 of the electronic device can be the second proportion, a proportion of the updated eighth window region 422′ to the user interface 400 of the electronic device can be the second proportion, the first proportion can be greater than the second proportion, and the configuring the eighth window region 422 as an updated first display region 410′ can comprise: zooming in the eighth window region until the proportion of the eighth window region to the user interface of the electronic device increases to the first proportion; and the configuring the first display region 410 as an updated eighth window region 422′ in the second display region can comprise: zooming out the first display region until the proportion of the first display region to the user interface of the electronic device decreases to the second proportion.

According to some embodiments, the proportion of the first display region to the user interface of the electronic device refers to a ratio of a display area of the first display region to a display area of the user interface of the electronic device. The proportion of the updated first display region to the user interface of the electronic device refers to a ratio of a display area of the updated first display region to the display area of the user interface of the electronic device. The proportion of the eighth window region to the user interface of the electronic device refers to a ratio of a display area of the eighth window region to the display area of the user interface of the electronic device. The proportion of the updated eighth window region to the user interface of the electronic device refers to a ratio of a display area of the updated eighth window region to the display area of the user interface of the electronic device. According to some embodiments, the display area of the first display region can be equal to the display area of the updated first display region. In this way, the first display region and the updated first display region can remain visually consistent before and after the eighth window region is configured as the updated first display region, which improves the user's visual experience with respect to the window switching. Similarly, the display area of the eighth window region can be equal to the display area of the updated eighth window region. In this way, before and after the eighth window region is configured as the updated first display region, a total area of the second display region can be kept unchanged, so as to keep the overall layout of the user interface unchanged, which improves the visual experience. In addition, the display areas of the first display region and the updated first display region are the same, and the display areas of the eighth window region and the updated eighth window region are the same, there is no need to define more region sizes, which reduces the layout complexity of the user interface. In addition, a total display area after the window switching is the same as a total display area before the window switching, so that the display area is not wasted before and after the window switching, which improves the space utilization rate.

According to some embodiments, in a process of zooming in the eighth window region, the thirteenth application window displayed in the eighth window region can be zoomed in at the same time. According to other embodiments, in the process of zooming in the eighth window region, the thirteenth application window displayed in the eighth window region is not zoomed in at the same time.

According to some embodiments, the first display region is located on a first side of the user interface of the electronic device, the at least one window region in the second display region is located on a second side of the user interface of the electronic device, and the method further comprises: causing other window regions than the eighth window region in the at least one window region in the second display region to move from the second side of the user interface of the electronic device to the first side.

According to some embodiments, there can be no limitation on specific positions of the first and second sides in the present disclosure. For example, the first side can be a left side, a right side, an upper side, a lower side, an upper left side, a lower left side, an upper right side, a lower right side of the user interface, or any suitable position for the display on the user interface, etc. Similarly, the second side can be the left side, right side, upper side, lower side, upper left side, lower left side, upper right side, lower right side, or any suitable position for the display on the user interface, etc. According to some embodiments, there can be various combinations of the first and second sides. For example, if the first side is the left side and the second side is the lower side, the other window regions than the eighth window region in the at least one window region in the second display region moves from the lower side of the user interface of the electronic device to the left side of the user interface. For another example, if the first side is the lower left side and the second side is the upper right side, the other window regions than the eighth window region in the at least one window region in the second display region moves from the upper right side of the user interface of the electronic device to the lower left side of the user interface.

According to some embodiments, the first display region is located on the first side of the user interface of the electronic device, the at least one window region in the second display region is located on the second side of the user interface of the electronic device, the first side is opposite the second side, and the method further comprises: causing the other window regions than the eighth window region in the at least one window region to move from the second side of the user interface of the electronic device to the first side.

According to some embodiments, referring to the first to the second stages of FIG. 4, the first display region 410 can be located on a first side of the user interface 400 of the electronic device, the at least one window region 421, 422, 423, 424 in the second display region can be located on a second side of the user interface of the electronic device, the first side can be opposite the second side, and the method of operating the electronic device can further comprise: in a process of zooming in the eighth window region, causing other window regions 421, 423, 424 than the eighth window region in the at least one window region in the second display region 420 to move from the second side of the user interface of the electronic device to the first side.

According to some embodiments, for example as shown in FIG. 4, the first side and the second side can refer to the left side and the right side, respectively, of the user interface of the electronic device. Of course, the first side and the second side can also refer to the upper side and the lower side, respectively, of the user interface of the electronic device. In such a way, on the user interface of the electronic device, a region of the eighth window region after being zoomed in to the updated first display region completely covers a region of the eighth window region before being zoomed in, so that a zooming-in animation where the eighth window region is zoomed in remains consistent, which further improves the visual experience of the user. In addition, since the region of the eighth window region after being zoomed in to the updated first display region completely covers the region of the eighth window region before being zoomed in, the input for the thirteenth application window is always located in the eighth window region or the updated first display region (the zoomed-in eighth window region), and the user can directly interact with the thirteenth application window without the need of further movement after the eighth window region is zoomed in, so that the movement path is reduced, and the operation is convenient. The exemplary method of operating the electronic device according to the present disclosure has been described above in conjunction with the accompanying drawings. An exemplary apparatus for operating an electronic device and an exemplary embodiment of the electronic device of the present disclosure will be further described below in conjunction with the accompanying drawings.

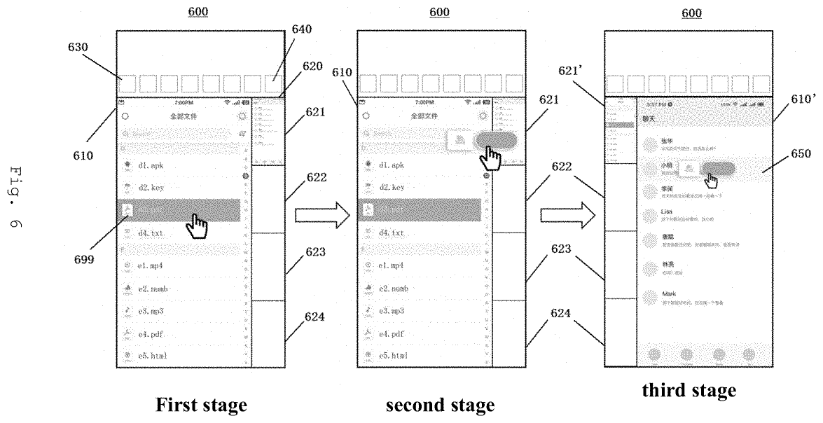

FIG. 7 is a structural block diagram illustrating an apparatus for operating an electronic device according to an exemplary embodiment of the present disclosure.

A third aspect of the present disclosure can comprise an apparatus for operating an electronic device.

As shown in FIG. 7, the apparatus 700 for operating the electronic device can comprise: an input receiving unit 701 configured to receive a partition display input for a user interface of the electronic device; and a partition display unit 702 configured to in response to the partition display input, partition the user interface of the electronic device and display a partition result, wherein the partition result comprises a first display region and a second display region, the first display region being capable of performing functions of a first function set, the second display region being capable of performing functions of a second function set, the second display region comprising at least one window region, each window region in the at least one window region being configured to be capable of displaying one application window.

According to some embodiments, the apparatus 700 for operating the electronic device can further comprise units configured to perform other steps of any of the methods described above.

The exemplary apparatus for operating the electronic device of the present disclosure has been briefly described above. It should be noted that specific implementations of exemplary units or features of the apparatus for operating the electronic device according to the present disclosure can refer to specific implementations of corresponding features in the above exemplary method for operating the electronic device according to the present disclosure, and therefore, they will not be repeated. In addition, the units involved in describing the exemplary apparatus for operating the electronic device according to the present disclosure can be implemented by software, and can also be implemented by hardware, wherein a name of an unit does not, in some cases, constitute a limitation on the unit itself.

In addition, exemplary functions of the units of the apparatus for operating the electronic device according to the present disclosure can be performed, at least in part, by one or more hardware logic components. For example, without limitation, an exemplary type of hardware logic component that can be used comprises: field programmable gate array (FPGA), application specific integrated circuit (ASIC), application specific standard product (ASSP), system on chip (SOC), complex programmable logic device (CPLD), and the like.

A fourth aspect of the present disclosure can comprise an electronic device, which can comprise a processor; and a memory having therein stored a program, the program comprising instructions which, when executed by the processor, cause the processor to perform any of the methods described above.

A fifth aspect of the present disclosure can comprise a storage medium having therein stored a program, the program comprising instructions which, when executed by a processor of an electronic device, cause the electronic device to perform any of the methods described above.

A sixth aspect of the present disclosure can comprise a computer program product comprising a program, the program comprising code which, when executed by a processor of an electronic device, causes the electronic device to perform any of the methods described above.

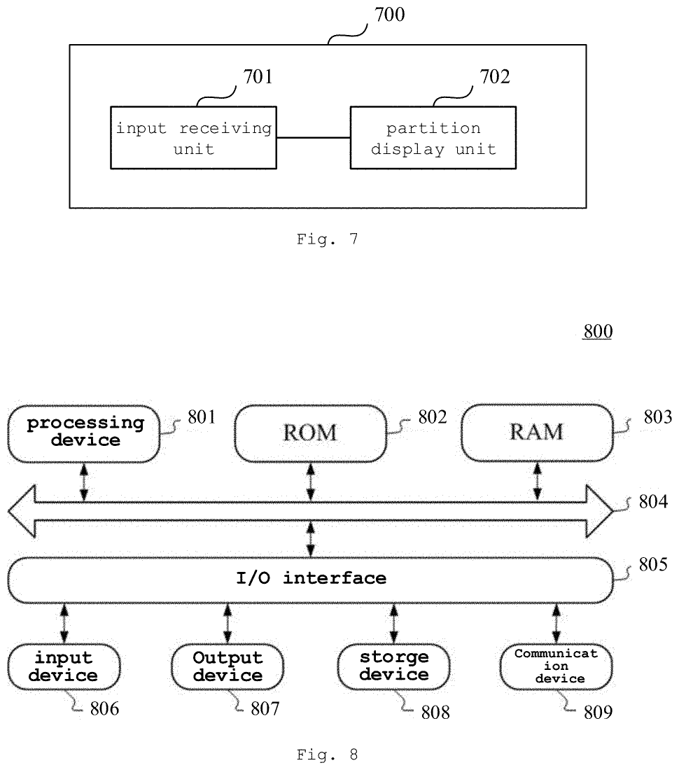

Reference will be made below to FIG. 8, which illustrates a structural schematic diagram suitable for an electronic device 800 (for example, the electronic device in the present disclosure) for implementing an embodiment of the present disclosure. The electronic device shown in FIG. 8 is only an example, and should not bring any limitation on functions and use scopes of the embodiments of the present disclosure.

As shown in FIG. 8, the electronic device 800 can comprise a processing device (for example, a central processing unit, a graphics processor, etc.) 801, which can perform various appropriate actions and processes according to a program stored in a read-only memory (ROM) 802 or a program loaded from a storage device 806 into a random access memory (RAM) 803. In the RAM 803, various programs and data required for an operation of the electronic device 800 are also stored. The processing device 801, the ROM 802, and the RAM 803 are connected to each other through a bus 804. An input/output (I/O) interface 805 is also connected to the bus 804.

Generally, the following devices can be connected to the I/O interface 805: an input device 806, comprising, for example, a touch screen, touch pad, keyboard, mouse, camera, microphone, accelerometer, gyroscope, or the like; an output device 807, comprising, for example, a liquid crystal display (LCD), speaker, vibrator, or the like; a storage device 808, comprising, for example, a magnetic tape, hard disk, or the like; and a communication device 809. The communication device 809 can allow the electronic device 800 to be in wireless or wire communication with other devices to exchange data. Although FIG. 8 illustrates the electronic device 800 having various devices, it should be understood that not all illustrated devices are required to be implemented or provided. More or fewer devices can be alternatively implemented or provided.

Particularly, according to an embodiment of the present disclosure, a process described above with reference to a flowchart can be implemented as a computer software program. For example, an embodiment of the present disclosure comprises a computer program product comprising a computer program carried on a non-transitory computer-readable medium, the computer program containing program code for performing a method illustrated by the flowchart. In such an embodiment, the computer program can be downloaded and installed from a network via the communication device 809, or installed from the storage device 806, or installed from the ROM 802. The computer program, when executed by the processing device 801, performs the above functions defined in the method of the embodiment of the present disclosure.

It should be noted that the storage medium described above in the present disclosure can be a computer-readable storage medium. The computer-readable storage medium can be, for example, but is not limited to, an electronic, magnetic, optical, electromagnetic, infrared, or semiconductor system, apparatus, or device, or any combination of the foregoing. More specific examples of the computer-readable storage medium can comprise, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In this disclosure, the computer-readable storage medium can be any tangible medium having therein embodied or stored a program that can be used by or in conjunction with an instruction execution system, apparatus, or device. However, in this disclosure, a computer-readable signal medium can comprise a data signal propagated in baseband or as part of a carrier wave, in which computer-readable program code is carried. Such a propagated data signal can take a variety of forms that comprise, but are not limited to, an electro-magnetic signal, an optical signal, or any suitable combination of the foregoing. The computer-readable signal medium can also be any computer-readable medium other than the computer-readable storage medium, and the computer-readable signal medium can send, propagate, or transmit a program for use by or in conjunction with an instruction execution system, apparatus, or device. The program code embodied in the computer-readable medium can be transmitted using any appropriate medium that comprises, but is not limited to: an electrical wire, an optical cable, RF (radio frequency), or the like, or any suitable combination of the foregoing.

In some implementations, an example of the communication network comprise a local area network (“LAN”), a wide area network (“WAN”), an internet (for example, Internet) and a peer-to-peer network (for example, an ad hoc peer-to-peer network), and any currently known or future developed network.

The above computer-readable medium can be embodied in the electronic device; or it can be alone without being assembled into the electronic device.

The above computer-readable medium has therein carried one or more programs which, when executed by the electronic device, cause the electronic device to: receive a partition display input for a user interface of the electronic device; and in response to the partition display input, partition the user interface of the electronic device and display a partition result, wherein the partition result comprises a first display region and a second display region, the first display region being capable of performing functions of a first function set, the second display region being capable of performing functions of a second function set, the second display region comprising at least one window region, each window region in the at least one window region being configured to be capable of displaying one application window.

The computer program code for performing an operation of the present disclosure can be written in one or more programming languages or a combination thereof, wherein the above programming languages comprise, but are not limited to, an object-oriented programming language such as Java, Smalltalk, C++, and also comprise a conventional procedural programming language, such as the “C” programming language or a similar programming language. The program code can be executed entirely on a user's computer, partly on the user's computer, as a stand-alone software package, partly on the user's computer and partly on a remote computer, or entirely on the remote computer or server. In a case where the remote computer is involved, the remote computer can be connected to the user's computer through any type of network, comprising a local area network (LAN) or a wide area network (WAN), or it can be connected to an external computer (for example, through the Internet using an Internet service provider).

Flowcharts and block diagrams in the accompanying drawings illustrate a practicable architecture, functions, and operations of systems, methods and computer program products according to various embodiments of the present disclosure. In this regard, each block in the flowcharts or block diagrams can represent a portion of a module, program segment, or code, which comprises one or more executable instructions for implementing specified logical functions. It should also be noted that, in some alternative implementations, functions noted in blocks can occur in an order different from an order noted in the drawings. For example, two blocks shown in succession can, in fact, be executed substantially in parallel, and they can sometimes be executed in a reverse order, which depends upon the functions involved. It will also be noted that each block of the block diagrams and/or flowcharts, and a combination of blocks in the block diagrams and/or flowcharts, can be implemented by using a special-purpose hardware-based system that perform specified functions or operations, or by using a combination of special-purpose hardware and computer instructions.

In the context of this disclosure, a machine-readable medium can be a tangible medium that can have therein embodied or stored a program for use by or in conjunction with an instruction execution system, apparatus, or device. The machine-readable medium can be a machine-readable signal medium or a machine-readable storage medium. The machine-readable medium can comprise, but is not limited to, an electronic, magnetic, optical, electromagnetic, infrared, or semiconductor system, apparatus, or device, or any suitable combination of the foregoing. More specific examples of the machine-readable storage medium can comprise an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The foregoing description is only preferred embodiments of the present disclosure and explanations for employed technical principles. It should be understood by those skilled in the art that the disclosure scope involved in this disclosure is not limited to technical solutions formed by a specific combination of the above technical features, but also encompasses other technical solutions formed by an arbitrary combination of the above technical features or their equivalent features without departing from the above disclosure concept. For example, a technical solution is formed by interchanging the above features with technical features having functions similar to functions disclosed (but not limited to) in the present disclosure.

Furthermore, although operations are depicted in a specific order, this should not be understood as requiring that these operations be performed in the specific order shown or in a sequential order. Under certain circumstances, multitasking and parallel processing can be advantageous. Similarly, although several specific implementation details are comprised in the above discussion, these should not be construed as limitations on the scope of the present disclosure. Certain features that are described in the context of individual embodiments can also be implemented in combination in a single embodiment. Conversely, features that are described in the context of a single embodiment can also be implemented in a plurality of embodiments individually or in any suitable sub-combination.

Although the subject matter has been described in language specific to structural features and/or method logical actions, it should be understood that the subject matter defined in the attached claims is not necessarily limited to the specific features or actions described above. On the contrary, the specific features and actions described above are only exemplary forms of implementing the claims.

1. A method of operating an electronic device, comprising:
receiving a partition display input for a user interface of the electronic device; and
partitioning the user interface of the electronic device and displaying a partition result, in response to the partition display input,
wherein the partition result comprises a first display region configured to perform a function of a first function set and a second display region configured to perform a function of a second function set, the second display region comprising at least one window region, each window region in the at least one window region being configured to display one application window.

2. The method according to claim 1, wherein identification information corresponding to a first application is displayed in the first display region, and the method further comprises:
receiving the identification information corresponding to the first application displayed in the first display region and a first window creation input for a first window region in the at least one window region displayed in the second display region; and
displaying, in the first window region, a first application window corresponding to the first application, in response to the first window creation input.

3. The method according to claim 2, wherein the identification information is a first application tab in a task manager window corresponding to the first application, and displaying, in the first window region, a first application window corresponding to the first application, in response to the first window creation input comprises at least one of following steps:
displaying a thumbnail of the first application window, causing the thumbnail of the first application window to move and to enter the first window region, and displaying the first application window in the first window region, in response to the first window creation input; or
displaying a thumbnail of the first application window, causing the thumbnail of the first application window to move, in response to the first window creation input, and not displaying the first application window in the first window region, in response to detecting that the thumbnail of the first application window does not move and enter the first window region; and
the method further comprising one of the following steps:
removing the second application window from the first window region in response to the first window creation input, if a second application window corresponding to a second application is being displayed in the first window region, before the first window creation input has been received;
moving the second application window to the second window region in response to the first window creation input, if the second application window corresponding to the second application is being displayed in the first window region and if no application window is being displayed in the second window region in the at least one window region displayed in the second display region, before the first window creation input has been received.

4. (canceled)

5. (canceled)

6. The method according to claim 3, further comprising:
detecting an entry speed of the thumbnail of the first application window when the thumbnail of the first application window entering enters entering the first window region; comparing the entry speed with a speed threshold; wherein if the entry speed is greater than the speed threshold, the removing the second application window from the first window region comprising at least one of following steps:
no longer displaying the second application window, in the first window region, and displaying the first application window; or
detecting an entry speed of the thumbnail of the first application window when entering the first window region; comparing the entry speed with a speed threshold; wherein if the entry speed is less than or equal to the speed threshold, the removing the second application window from the first window region comprising: determining a first direction based on a position of the first window region in the user interface of the electronic device; and causing the second application window to move in the first direction until the second application window moves out of the first window region; or
running the second application window in a background, if the second application window is locked by the task manager; and closing the second application window, if the second application window is not locked by the task manager.

7. (canceled)

8. (canceled)

9. (canceled)

10. (canceled)

11. The method according to claim 2, wherein the identification information corresponding to the first application comprise at least one of the first application window corresponding to the first application, a first application tab in a task manager corresponding to the first application, or a first application icon in a system desktop corresponding to the first application.

12. The method according to claim 1, further comprising at least one of the following steps:
receiving a window deletion input for a third application window, in a state where the third application window corresponding to a third application is being displayed in a third window region in the at least one window region,
removing the third application window from the third window region, in response to the window deletion input;
receiving a first window switching input for the fourth application window displayed in the first display region and a fourth window region in the at least one window region displayed in the second display region, in a state where the fourth application window is being displayed in the first display region, displaying the fourth application window in the fourth window region, in response to the first window switching input;
receiving a first window switching input for the fourth application window displayed in the first display region and a fourth window region in the at least one window region displayed in the second display region, in a state where the fourth application window is being displayed in the first display region, displaying the fourth application window in the fourth window region, in response to the first window switching input;
receiving a second window switching input for a fifth window region, in a state where a sixth application window is being displayed in the fifth window region in the at least one window region displayed in the second display region, displaying the sixth application window in the first display region, in response to the second window switching input;
receiving an input for an eighth application window, in a state where the eighth application window is being displayed in a sixth window region in the at least one window region displayed in the second display region, activating the eighth application window, configuring the sixth window region as an updated first display region, and configuring the first display region as an updated sixth window region in the second display region, in response to the input for the eighth application window; or
receiving a first copying input for to-be-copied content comprised in a ninth application window and a seventh window region, in a case where the ninth application window is being displayed in the first display region and a tenth application window is being displayed in the seventh window region in the at least one window region in the second display region, copying the to-be-copied content into the tenth application window, in response to the first copying input.

13. (canceled)

14. (canceled)

15. (canceled)

16. The method according to claim 12, further comprising at least one of the following steps:
displaying a fifth application window in the first display region, in response to the first window switching input, wherein the fifth application window was displayed in the fourth window region before the first window switching input has been received; or
displaying a seventh application window in the fifth window region, in response to the second window switching input, wherein the seventh application window was displayed in the first display region before the second window switching input has been received and
wherein a proportion of the first display region to the user interface of the electronic device is a first proportion, a proportion of the updated first display region to the user interface of the electronic device is the first proportion, a proportion of the sixth window region in the second display region to the user interface of the electronic device is a second proportion, a proportion of the updated sixth window region to the user interface of the electronic device is the second proportion, the first proportion is greater than the second proportion, and
the configuring the sixth window region as the updated first display region comprises:
zooming in the sixth window region until the proportion of the sixth window region to the user interface of the electronic device increases to the first proportion; and
the configuring the first display region as the updated sixth window region in the second display region comprises: zooming out the first display region until the proportion of the first display region to the user interface of the electronic device decreases to the second proportion.

17. (canceled)

18. (canceled)

19. (canceled)

20. (canceled)

21. The method according to claim 16, wherein the first display region is located on a first side of the user interface of the electronic device, the at least one window region in the second display region is located on a second side of the user interface of the electronic device, the first side is opposite the second side, and
the method further comprises:
causing other window regions than the sixth window region in the at least one window region in the second display region to move from the second side of the user interface of the electronic device to the first side, in a process of zooming in the sixth window region.

22. The method according to claim 12, wherein a previous application window is being displayed in the first display region, before the input for the eighth application window has been received, and the method further comprises: displaying the previous application window in the updated sixth window region; and
wherein copying the to-be-copied content into the tenth application window, in response to the first copying input comprises:
selecting the to-be-copied content, causing the to-be-copied content to move and to enter the seventh window region, causing the to-be-copied content to stay at the seventh window region, copying the to-be-copied content into the tenth application window displayed in the seventh window region, in response to the first copying input, selecting the to-be-copied content.

23. (canceled)

24. (canceled)

25. (canceled)

26. The method according to claim 22, wherein if the staying time is greater than the first threshold time, the method further comprises:
configuring the seventh window region as an updated first display region and displaying, in the updated first display region, the tenth application window, and configuring the first display region as an updated seventh window region and displaying, in the updated seventh window region, the ninth application window; and
wherein a proportion of the first display region and the updated first display region to the user interface of the electronic device is a first proportion, a proportion of the seventh window region in the second display region and the updated seventh window region to the user interface of the electronic device is a second proportion, the first proportion can be greater than the second proportion, and
the configuring the seventh window region as the updated first display region comprises:
zooming in the seventh window region until the proportion of the seventh window region to the user interface of the electronic device increases to the first proportion; and
the configuring the first display region as the updated seventh window region in the second display region comprises:
zooming out the first display region until the proportion of the first display region to the user interface of the electronic device decreases to the second proportion.

27. (canceled)

28. (canceled)

29. The method according to claim 26, wherein the first display region is located on a first side of the user interface of the electronic device, the at least one window region in the second display region is located on a second side of the user interface of the electronic device, the first side is opposite the second side, and the method further comprises:
causing other window regions than the seventh window region in the at least one window region in the second display region to move from the second side of the user interface of the electronic device to the first side, as the seventh window region is zoomed in.

30. The method according to claim 29, wherein a position of the to-be-copied content to stay at the seventh window region is caused as a staying position, and
the staying position is located in the tenth application window displayed in the updated first display region, after the seventh window region is configured as the updated first display region and the first display region is configured as the updated seventh window region.

31. (canceled)

32. (canceled)

33. The method according to claim 1, further comprising at least one of following steps:
receiving a second copying input for a second file in the at least one file and a target application window displayed in the first display region or one arbitrary window region in the at least one window region displayed in the second display region, copying the second file into the target application window for calling by the target application window, in response to the second copying input; or
displaying at least one file in the file display region, wherein the partition result further comprises a file display region.

34. (canceled)

35. (canceled)

36. (canceled)

37. The method according to claim 33, wherein the file display region is displayed between boundaries of the first display region and the user interface of the electronic device.

38. The method according to claim 1, wherein the application icon display region is displayed between the boundaries of the first display region and the user interface of the electronic device, the partition result further comprises an application icon display region, and the method further comprises:
displaying at least one application icon in the application icon display region;
the method further comprising at least one of the following steps:
receiving a first opening input for a first application icon of the at least one application icon, displaying an application window corresponding to the first application icon in the first display region, in response to the first opening input; or
receiving a second opening input for a second application icon of the at least one application icon and one arbitrary window region in the at least one window region, or
displaying an application window corresponding to the second application icon in the one arbitrary window region, in response to the second opening input.

39. (canceled)

40. (canceled)

41. (canceled)

42. The method according to any of claims 1 to 41, wherein the functions of the first function set comprise: displaying the system desktop window, allowing a user to interact with the system desktop corresponding to the system desktop window, displaying the task manager window, allowing the user to interact with task management corresponding to the task manager window, displaying the application window, and allowing the user to interact with an application corresponding to the application window, or
an application window displayed in the first display region is active, and an application window displayed in each window region in the at least one window region displayed in the second display region is active, or
an aspect ratio of the first display region is equal to an aspect ratio of the user interface of the electronic device, the partition display input is a sliding input, and the partitioning the user interface of the electronic device and displaying the partition result, in response to the partition display input further comprises:
detecting a sliding direction of the partition display input;
determining a third direction based on the sliding direction of the partition display input;
zooming out the user interface of the electronic device in such a way that a center of the user interface of the electronic device moves in the third direction, wherein the aspect ratio of the user interface of the electronic device remains unchanged in a process of zooming out the user interface of the electronic device; and
configuring the zoomed-out user interface of the electronic device as the first display region.

43. The method according to claim 42, wherein the second function set is a subset of the first function set.

44. (canceled)

45. (canceled)

46. (canceled)

47. (canceled)

48. The method according to claim 42, wherein the second display region comprises a predetermined-number of window regions, a width and a height of each window region in the predetermined-number of window regions is identical with each other, a sum of a width of the first display region and a width of the second display region is equal to a width of the user interface of the electronic device, and a height of the first display region is equal to predetermined-number times the height of each window region.

49. The method according to claim 1, wherein an eleventh application window is displayed in the first display region, and the method further comprises:
receiving a second window creation input for one arbitrary idle window region in the second display region; and
displaying the eleventh application window in the second display region, in response to the second window creation input.

50. The method according to claim 49, wherein the displaying the eleventh application window in the second display region further comprises:
displaying the eleventh application window in the one arbitrary idle window region in the second display region, or
displaying the eleventh application window in one idle window region adjacent to an occupied window region, in the second display region, or
displaying the eleventh application window in an idle window region closest to a triggering position of the second window creation input, in the second display region.

51. (canceled)

52. The method according to claim 49, further comprising:
displaying, in the first display region, the system desktop window or the task manager window or the eleventh application window or an application window displayed in the first display region before the eleventh application window, in response to the second window creation input.

53. (canceled)

54. A method of operating an electronic device, the method comprising:
receiving a switching input for a thirteenth application window, a user interface of the electronic device comprising a first display region and a second display region, the second display region comprising at least one window region, the thirteenth application window being displayed in an eighth window region of the at least one window region in the second display region; and
activating the thirteenth application window, configuring the eighth window region as an updated first display region, and configuring the first display region as an updated eighth window region, in response to the switching input.

55. The method according to claim 54, wherein the updated first display region covers the eighth window region,
a proportion of the first display region to the user interface of the electronic device is a first proportion, a proportion of each window region in the at least one window region in the second display region to the user interface of the electronic device is a second proportion, the first proportion is greater than the second proportion, the method further comprises: zooming in the eighth window region until a proportion of the eighth window region to the user interface of the electronic device increases to the first proportion, and zooming out the first display region until the proportion of the first display region to the user interface of the electronic device decreases to the second proportion, in response to the switching input, or
before the switching input has been received, a twelfth application window is displayed in the first display region, and the method further comprises: displaying the thirteenth application window in the updated first display region and displaying the twelfth application window in the updated eighth window region, in response to the switching input.

56. (canceled)

57. The method according to claim 55, wherein the first display region is located on a first side of the user interface of the electronic device, the at least one window region in the second display region is located on a second side of the user interface of the electronic device, and the method further comprises:
causing other window regions than the eighth window region in the at least one window region in the second display region to move from the second side of the user interface of the electronic device to the first side.

58. (canceled)

59. (canceled)

60. (canceled)

61. An electronic device, comprising:
a processor; and
a memory having therein stored a program, the program comprising instructions which, when executed by the processor, cause the processor to perform the method according to claim 1.

62. A non-transitory storage medium having therein stored a program, the program comprising instructions which, when executed by a processor of an electronic device, cause the electronic device to perform the method according to claim 1.
